(19) United States
(12) Patent Application Publication
(10) Pub. No.: US 2025/0069238 A1
(43) Pub. Date: Feb. 27, 2025

(54) TIME SEGMENTS OF VIDEO DATA AND ASSOCIATED OBJECT MOVEMENT PATTERNS

(71) Applicant: TORC Robotics, Inc., Blacksburg, VA (US)

(72) Inventors: Dalong Li, Blacksburg, VA (US); Syed Taha Shoaib, Blacksburg, VA (US); Juncong Fei, Blacksburg, VA (US)

(73) Assignee: TORC Robotics, Inc., Blacksburg, VA (US)

(21) Appl. No.: 18/238,439

(22) Filed: Aug. 25, 2023

(51) Int. Cl. G06T 7/246

(52) U.S. Cl. CPC G06T 7/248; G06T 2207/10016; G06T 2207/20081; G06T 2207/30252

(57) ABSTRACT

Aspects of this technical solution can include obtaining, by one or more processors coupled with non-transitory memory, a first plurality of images each including corresponding first time stamps, the plurality of images corresponding to video data of a physical environment, extracting, by the one or more processors and from among the first plurality of images, a second plurality of images each having corresponding second time stamps and each having corresponding features indicating an object in the physical environment, and training, by the one or more processors and with input including the features and the second time stamps corresponding to the features, a machine learning model to generate an output indicating a pattern of movement of one or more objects corresponding to the features and the second time stamps corresponding to the features.

### TECHNICAL FIELD

The present implementations relate generally to computer vision, including but not limited to artificial intelligence trained to segment video data and associated object movement patterns.

### BACKGROUND

Due to the real-time nature of vehicle navigation, accurate detection of the physical environment is paramount for operating autonomous vehicles on public roadways. However, conventional approaches can fail to effectively detect the physical environment, particularly, where physical objects perform various maneuvers and movements during a single video recording, including cascading between movements of different objects.

### SUMMARY

This technical solution is directed at least to analysis and segmentation of video data using artificial intelligence models, specifically to determine one or more time segments of video data and to determine one or more object movement patterns associated with a segment of video data. As a result, this technical solution provides improvements to computer vision including enabling more accurate object avoidance and increased responsivity in automatic vehicle controls. This technical solution provides systems and methods for improved detection of moving objects, and more accurate prediction of object movements, using video data that is organized into one or more corresponding segments. Thus, a technical solution for using artificial intelligence models to generate segmented video data and determine object movement patterns associated with the segmented video is provided.

At least one aspect is directed to a method. The method can include obtaining, by one or more processors coupled with non-transitory memory, a first plurality of images each can include corresponding first time stamps, the plurality of images corresponding to video data of a physical environment. The method can include extracting, by the one or more processors and from among the first plurality of images, a second plurality of images each having corresponding second time stamps and each having corresponding features indicating an object in the physical environment. The method can include training, by the one or more processors and with input can include the features and the second time stamps corresponding to the features, a machine learning model to generate an output indicating a pattern of movement of one or more objects corresponding to the features and the second time stamps corresponding to the features.

At least one aspect is directed to a system. The system can include one or more processors coupled to non-transitory memory. The system can obtain a first plurality of images each can include corresponding first time stamps, the plurality of images corresponding to video data of a physical environment. The system can extract, from among the first plurality of images, a second plurality of images each having corresponding second time stamps and each having corresponding features indicating an object in the physical environment. The system can train, with input can include the features and the second time stamps corresponding to the features, a machine learning model to generate an output indicating a pattern of movement of one or more objects corresponding to the features and the second time stamps corresponding to the features.

At least one aspect is directed to a non-transitory computer readable medium can include one or more instructions stored thereon and executable by a processor. The processor can obtain a first plurality of images each can include corresponding first time stamps, the plurality of images corresponding to video data of a physical environment. The processor can extract, from among the first plurality of images, a second plurality of images each having corresponding second time stamps and each having corresponding features indicating an object in the physical environment. The processor can train, with input can include the features and the second time stamps corresponding to the features, a machine learning model to generate an output indicating a pattern of movement of one or more objects corresponding to the features and the second time stamps corresponding to the features.

### BRIEF DESCRIPTION OF THE FIGURES

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 is a bird's eye view of a roadway including a schematic representation of a vehicle and aspects of an autonomy system of the vehicle, in accordance with present implementations.

FIG. 2 is a schematic of the autonomy system of the vehicle, in accordance with present implementations.

FIG. 3 is a schematic diagram of an object detection and tracking module of the autonomy system of the vehicle, in accordance with present implementations.

FIG. 4 is a schematic of a system for training artificial intelligence models with improved accuracy using image data, in accordance with present implementations.

FIG. 5A depicts an example video content architecture, in accordance with present implementations.

FIG. 5B depicts an example segmented video content architecture, in accordance with present implementations.

FIG. 6A depicts an example multi-feature video content architecture, in accordance with present implementations.

FIG. 6B depicts an example segmented multi-feature video content architecture, in accordance with present implementations.

FIG. 7 depicts an example machine learning model architecture, in accordance with present implementations.

FIG. 8 depicts an example method of determining one or more time segments for video data and the associated object movement patterns, in accordance with present implementations.

FIG. 9 depicts an example method of determining one or more time segments for video data and the associated object movement patterns, in accordance with present implementations.

FIG. 10 depicts an example method of comparing the motion predictions for one or more time segments of video data and the associated object movement patterns produced by a machine leaning-based model and actual measured motion.

FIG. 11 depicts an example augmentation for a machine learning based model to predict the motion of one or more vehicles, in accordance with present implementations.

### DETAILED DESCRIPTION

Aspects of this technical solution are described herein with reference to the figures, which are illustrative examples of this technical solution. The figures and examples below are not meant to limit the scope of this technical solution to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, this technical solution and the present implementations encompass present and future known equivalents to the known components referred to herein by way of description, illustration, or example.

Present implementations can advantageously automatically train one or more models to organize video data, organized as timestamped images, into one or more segments and one or more models to determine the objects and object movement patterns within the one or more segments of video data. A system can, for example, automatically select a supervised machine learning model based on one or more characteristics of the video data, including number and type of objects identified in the images of the video data. As one example, video data can include a time step, or frame rate, associated with the difference between each timestamp of the images in the video data. A time step can be a predetermined time step such as a second, or less, between timestamps of the frames of the video data, in which an image, or frame, appears associated with that time step. A normalization process can include normalizing a time step (e.g., reducing the number of frames in the video data) to associate each video dataset with a single time step (e.g., a specific framerate or number of frames per second) having a particular granularity. Thus, a particular set of input video data having a quarter second time step normalized to a half second time step may include half the number of images, because of the additional time steps that do not appear in the normalized video data.

The system can train and include, or access, multiple models each operable to generate one or more time segments of the time range (e.g., duration) of the video data based on the objects and movements captured in the images of the video data. The multiple models can include supervised machine learning models, and can each be optimized, for example, to generate accurate machine learning models from video data having various characteristics including but not limited to particular objects, object movements, interactions between objects, or the like. The system can then select an object movement model for each segment of video data, based on the content, objects, or object movement(s), in each of the segments, for example. Each model can thus be assigned to a particular video segment to which it is best optimized, to increase accuracy of object patterns and object movement types determined by a combined model including, referencing, or integrating, for example, each of the multiple models for the individual segments of the video data. Each of the multiple models can then be combined into a combined model advantageously capable of automatically generating an output including one or more object movement patterns and one or more object movement types based on one of the models associated with a particular segment of the video data, based on a characteristic of the object(s) and movement(s) captured in the images of that segment. Thus, a system can advantageously obtain a request for determining one or more segments for video data and one or more associated object movement pattern(s) of each segment.

As one example, a combined model can determine a segment of video data and determine that it is associated with a breaking movement by a first vehicle, including a sudden deceleration of the first vehicle, and determine one or more movement patterns of at least one additional vehicle as a result of the sudden deceleration of the first vehicle. A system can receive input video data including a plurality of images with corresponding time stamps, each of which depicts the first vehicle and the at least one additional vehicle at the time indicated by the corresponding timestamp of that image. The movement of the first vehicle (e.g., sudden breaking maneuver) can be associated with particular subset of the frames included in the video data (e.g., breaking then accelerating due to heavy traffic) and can also be associated with one or more additional objects (e.g., a pedestrian entering a roadway to cause the sudden breaking movement, breaking by one or more additional vehicles located behind the first vehicle and in response to the sudden deceleration of the first vehicle, etc.). Present implementations can receive video data including frames (e.g., images with corresponding time stamps) for creation of all segments of the video data and can automatically organize the frames into segments of video data based on one or more features of the content (e.g., objects, events, scenarios, etc.) captured in the video data.

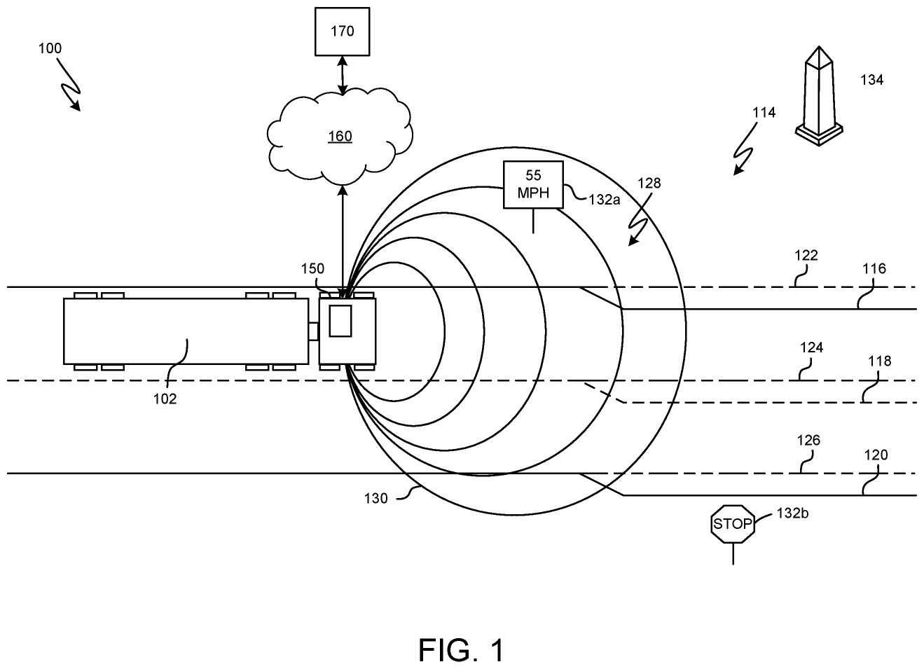

Referring to FIG. 1, the present disclosure relates to autonomous vehicles, such as an autonomous truck 102 having an autonomy system 150. The autonomy system 150 of truck 102 may be completely autonomous (fully-autonomous), such as self-driving, driverless, or Level 4 autonomy, or semi-autonomous, such as Level 3 autonomy. As used herein the term “autonomous” includes both fully-autonomous and semi-autonomous. The present disclosure sometimes refers to autonomous vehicles as ego vehicles. The autonomy system 150 may be structured on at least three aspects of technology: (1) perception, (2) maps/localization, and (3) behaviors planning and control. The function of the perception aspect is to sense an environment surrounding truck 102 and interpret it. To interpret the surrounding environment, a perception module or engine in the autonomy system 150 of the truck 102 may identify and classify objects or groups of objects in the environment. For example, a perception module associated with various sensors (e.g., LiDAR, camera, radar, etc.) of the autonomy system 150 may identify one or more objects (e.g., pedestrians, vehicles, debris, etc.) and features of the roadway (e.g., lane lines) around truck 102, and classify the objects in the road distinctly.

The maps/localization aspect of the autonomy system 150 may be configured to determine where on a pre-established digital map the truck 102 is currently located. One way to do this is to sense the environment surrounding the truck 102 (e.g., via the perception system) and to correlate features of the sensed environment with details (e.g., digital representations of the features of the sensed environment) on the digital map.

Once the systems on the truck 102 have determined its location with respect to the digital map features (e.g., location on the roadway, upcoming intersections, road signs, etc.), the truck 102 can plan and execute maneuvers and/or routes with respect to the features of the digital map. The behaviors, planning, and control aspects of the autonomy system 150 may be configured to make decisions about how the truck 102 should move through the environment to get to its goal or destination. It may consume information from the perception and maps/localization modules to know where it is relative to the surrounding environment and what other objects and traffic actors are doing.

FIG. 1 further illustrates an environment 100 for modifying one or more actions of truck 102 using the autonomy system 150. The truck 102 is capable of communicatively coupling to a remote server 170 via a network 160. The truck 102 may not necessarily connect with the network 160 or server 170 while it is in operation (e.g., driving down the roadway). That is, the server 170 may be remote from the vehicle, and the truck 102 may deploy with all the necessary perception, localization, and vehicle control software and data necessary to complete its mission fully-autonomously or semi-autonomously.

While this disclosure refers to a truck (e.g., a tractor trailer) 102 as the autonomous vehicle, it is understood that the truck 102 could be any type of vehicle including an automobile, a mobile industrial machine, etc. While the disclosure will discuss a self-driving or driverless autonomous system, it is understood that the autonomous system could be semi-autonomous having varying degrees of autonomy or autonomous functionality.

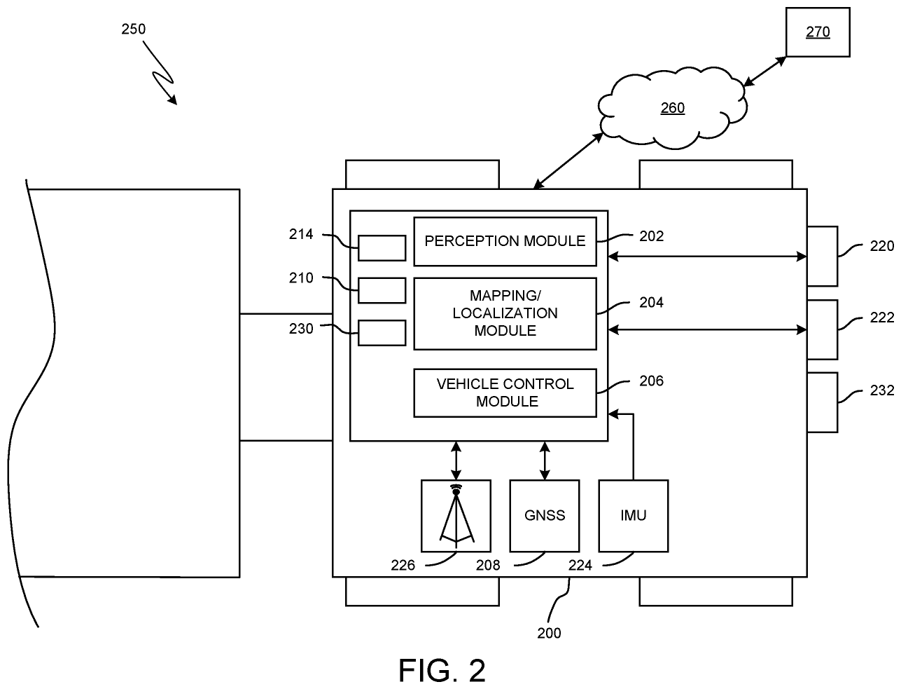

With reference to FIG. 2, an autonomy system 250 may include a perception system including a camera system 220, a LiDAR system 222, a radar system 232, a GNSS receiver 208, an inertial measurement unit (IMU) 224, and/or a perception module 202. The autonomy system 250 may further include a transceiver 226, a processor 210, a memory 214, a mapping/localization module 204, and a vehicle control module 206. The various systems may serve as inputs to and receive outputs from various other components of the autonomy system 250. In other examples, the autonomy system 250 may include more, fewer, or different components or systems, and each of the components or system(s) may include more, fewer, or different components. Additionally, the systems and components shown may be combined or divided in various ways. As show in FIG. 1, the perception systems aboard the autonomous vehicle may help the truck 102 perceive its environment out to a perception radius 130. The actions of the truck 102 may depend on the extent of perception radius 130.

The camera system 220 of the perception system may include one or more cameras mounted at any location on the truck 102, which may be configured to capture images of the environment surrounding the truck 102 in any aspect or field of view (FOV). The FOV can have any angle or aspect such that images of the areas ahead of, to the side, and behind the truck 102 may be captured. For example, the FOV may be limited to particular areas around the truck 102 (e.g., forward of the truck 102) or may surround 360 degrees of the truck 102. For example, the image data generated by the camera system(s) 220 may be sent to the perception module 202 and stored, for example, in memory 214. For example, the image data generated by the camera system(s) 220, as well as any classification data or object detection data (e.g., bounding boxes, estimated distance information, velocity information, mass information, etc.) generated by the object tracking and classification module 230, can be transmitted to the remote server 270 for additional processing (e.g., correction of detected misclassifications from the image data, training of artificial intelligence models, etc.).

The LiDAR system 222 may include a laser generator and a detector and can send and receive a LIDAR signals. The LiDAR signal can be emitted to and received from any direction such that LiDAR point clouds (or “LiDAR images”) of the areas ahead of, to the side, and behind the truck 200 can be captured and stored as LiDAR point clouds. For example, the truck 200 may include multiple LiDAR systems and point cloud data from the multiple systems may be stitched together. For example, the system inputs from the camera system 220 and the LiDAR system 222 may be fused (e.g., in the perception module 202). The LiDAR system 222 may include one or more actuators to modify a position and/or orientation of the LiDAR system 222 or components thereof. The LIDAR system 222 may be configured to use ultraviolet (UV), visible, or infrared light to image objects and can be used with a wide range of targets. The LiDAR system 222 can be used to map physical features of an object with high resolution (e.g., using a narrow laser beam). In some examples, the LiDAR system 222 may generate a point cloud and the point cloud may be rendered to visualize the environment surrounding the truck 200 (or object(s) therein). For example, the point cloud may be rendered as one or more polygon(s) or mesh model(s) through, for example, surface reconstruction. Collectively, the LiDAR system 222 and the camera system 220 may be referred to herein as “imaging systems.”

The radar system 232 may estimate strength or effective mass of an object, as objects made out of paper or plastic may be weakly detected. The radar system 232 may be based on 24 GHZ, 77 GHZ, or other frequency radio waves. The radar system 232 may include short-range radar (SRR), mid-range radar (MRR), or long-range radar (LRR). One or more sensors may emit radio waves, and a processor processes received reflected data (e.g., raw radar sensor data).

The GNSS receiver 208 may be positioned on the truck 200 and may be configured to determine a location of the truck 200 via GNSS data, as described herein. The GNSS receiver 208 may be configured to receive one or more signals from a global navigation satellite system (GNSS) (e.g., GPS system) to localize the truck 200 via geolocation. The GNSS receiver 208 may provide an input to and otherwise communicate with mapping/localization module 204 to, for example, provide location data for use with one or more digital maps, such as an HD map (e.g., in a vector layer, in a raster layer or other semantic map, etc.). In some instances, the GNSS receiver 208 may be configured to receive updates from an external network.

The IMU 224 may be an electronic device that measures and reports one or more features regarding the motion of the truck 200. For example, the IMU 224 may measure a velocity, acceleration, angular rate, and or an orientation of the truck 200 or one or more of its individual components using a combination of accelerometers, gyroscopes, and/or magnetometers. The IMU 224 may detect linear acceleration using one or more accelerometers and rotational rate using one or more gyroscopes. The IMU 224 may be communicatively coupled to the GNSS receiver 208 and/or the mapping/localization module 204, to help determine a real-time location of the truck 200, and predict a location of the truck 200 even when the GNSS receiver 208 cannot receive satellite signals.

The transceiver 226 may be configured to communicate with one or more external networks 260 via, for example, a wired or wireless connection in order to send and receive information (e.g., to a remote server 270). The wireless connection may be a wireless communication signal (e.g., Wi-Fi, cellular, LTE, 5g, etc.) For example, the transceiver 226 may be configured to communicate with external network(s) via a wired connection, such as, for example, during initial installation, testing, or service of the autonomy system 250 of the truck 200. A wired/wireless connection may be used to download and install various lines of code in the form of digital files (e.g., HD digital maps), executable programs (e.g., navigation programs), and other computer-readable code that may be used by the system 250 to navigate the truck 200 or otherwise operate the truck 200, either fully-autonomously or semi-autonomously. The digital files, executable programs, and other computer readable code may be stored locally or remotely and may be routinely updated (e.g., automatically or manually) via the transceiver 226 or updated on demand.

The truck 200 may not be in constant communication with the network 260 and updates which would otherwise be sent from the network 260 to the truck 200 may be stored at the network 260 until such time as the network connection is restored. For example, the truck 200 may deploy with all of the data and software it needs to complete a mission (e.g., necessary perception, localization, and mission planning data) and may not utilize any connection to network 260 during some or the entire mission. Additionally, the truck 200 may send updates to the network 260 (e.g., regarding unknown or newly detected features in the environment as detected by perception systems) using the transceiver 226. For example, when the truck 200 detects differences in the perceived environment with the features on a digital map, the truck 200 may update the network 260 with information, as described in greater detail herein.

The processor 210 of autonomy system 250 may be embodied as one or more of a data processor, a microcontroller, a microprocessor, a digital signal processor, a logic circuit, a programmable logic array, or one or more other devices for controlling the autonomy system 250 in response to one or more of the system inputs. Autonomy system 250 may include a single microprocessor or multiple microprocessors that may include means for identifying and reacting to differences between features in the perceived environment and features of the maps stored on the truck. Numerous commercially available microprocessors can be configured to perform the functions of the autonomy system 250. It should be appreciated that autonomy system 250 could include a general machine controller capable of controlling numerous other machine functions. Additionally, a special-purpose machine controller can be provided in some of the examples described herein. Further, the autonomy system 250, or portions thereof, may be located remote from the system 250. For example, one or more features of the mapping/localization module 204 could be located remote of truck. Various other known circuits may be associated with the autonomy system 250, including signal-conditioning circuitry, communication circuitry, actuation circuitry, and other appropriate circuitry.

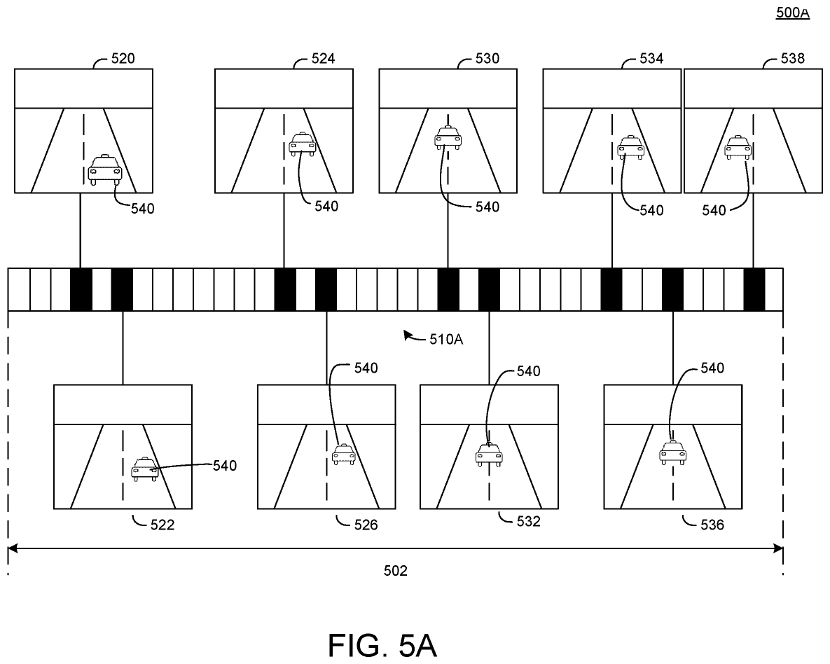

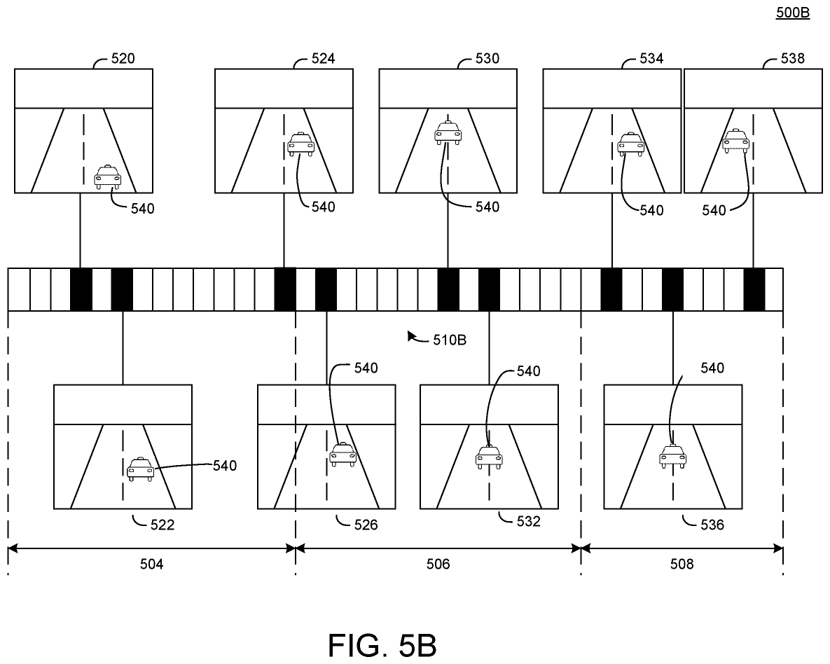

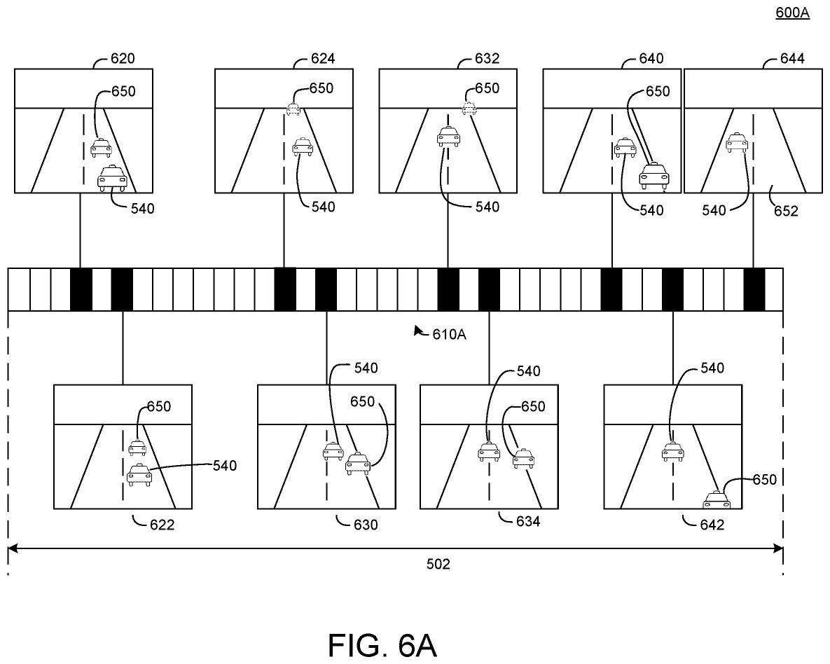

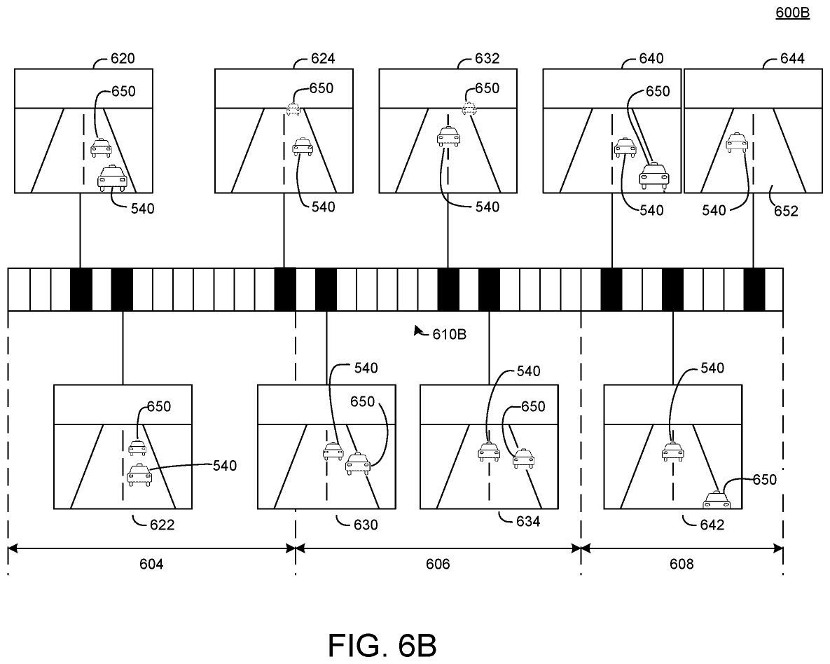

The memory 214 of autonomy system 250 may store data and/or software routines that may assist the autonomy system 250 in performing its functions, such as the functions of the perception module 202, the mapping/localization module 204, the vehicle control module 206, an object tracking and classification module 230, the method 500 described herein with respect to FIG. 5, and the method 600 described herein with respect to FIG. 6. Further, the memory 214 may also store data received from various inputs associated with the autonomy system 250, such as perception data from the perception system. For example, the memory 214 may store image data generated by the camera system(s) 220, as well as any classification data or object detection data (e.g., bounding boxes, estimated distance information, velocity information, mass information, etc.) generated by the object tracking and classification module 230.

As noted above, perception module 202 may receive input from the various sensors, such as camera system 220, LiDAR system 222, GNSS receiver 208, and/or IMU 224 (collectively “perception data”) to sense an environment surrounding the truck and interpret it. To interpret the surrounding environment, the perception module 202 (or “perception engine”) may identify and classify objects or groups of objects in the environment. For example, the truck 102 may use the perception module 202 to identify one or more objects (e.g., pedestrians, vehicles, debris, etc.) or features of the roadway 114 (e.g., intersections, road signs, lane lines, etc.) before or beside a vehicle and classify the objects in the road. For example, the perception module 202 may include an image classification function and/or a computer vision function. In some implementations, the perception module 202 may include, communicate with, or otherwise utilize the object tracking and classification module 230 to perform object detection and classification operations.

The system 100 may collect perception data. The perception data may represent the perceived environment surrounding the vehicle, for example, and may be collected using aspects of the perception system described herein. The perception data can come from, for example, one or more of the LiDAR system, the camera system, and various other externally-facing sensors and systems on board the vehicle (e.g., the GNSS receiver, etc.). For example, on vehicles having a sonar or radar system, the sonar and/or radar systems may collect perception data. As the truck 102 travels along the roadway 114, the system 100 may continually receive data from the various systems on the truck 102. For example, the system 100 may receive data periodically and/or continuously.

With respect to FIG. 1, the truck 102 may collect perception data that indicates presence of the lane lines 116, 118, 120. Features perceived by the vehicle should generally track with one or more features stored in a digital map (e.g., in the mapping/localization module 204). Indeed, with respect to FIG. 1, the lane lines that are detected before the truck 102 is capable of detecting the bend 128 in the road (that is, the lane lines that are detected and correlated with a known, mapped feature) will generally match with features in stored map and the vehicle will continue to operate in a normal fashion (e.g., driving forward in the left lane of the roadway or per other local road rules). However, in the depicted scenario the vehicle approaches a new bend 128 in the road that is not stored in any of the digital maps onboard the truck 102 because the lane lines 116, 118, 120 have shifted right from their original positions 122, 124, 126.

The system 100 may compare the collected perception data with stored data. For example, the system may identify and classify various features detected in the collected perception data from the environment with the features stored in a digital map. For example, the detection systems may detect the lane lines 116, 118, 120 and may compare the detected lane lines with lane lines stored in a digital map. Additionally, the detection systems could detect the road signs 132a, 132b and the landmark 134 to compare such features with features in a digital map. The features may be stored as points (e.g., signs, small landmarks, etc.), lines (e.g., lane lines, road edges, etc.), or polygons (e.g., lakes, large landmarks, etc.) and may have various properties (e.g., style, visible range, refresh rate, etc.), which properties may control how the system 100 interacts with the various features. Based on the comparison of the detected features with the features stored in the digital map(s), the system may generate a confidence level, which may represent a confidence of the vehicle in its location with respect to the features on a digital map and hence, its actual location.

The image classification function may determine the features of an image (e.g., a visual image from the camera system 220 and/or a point cloud from the LiDAR system 222). The image classification function can be any combination of software agents and/or hardware modules able to identify image features and determine attributes of image parameters in order to classify portions, features, or attributes of an image. The image classification function may be embodied by a software module (e.g., the object detection and classification module 230) that may be communicatively coupled to a repository of images or image data (e.g., visual data and/or point cloud data) which may be used to detect and classify objects and/or features in real time image data captured by, for example, the camera system 220 and the LiDAR system 222. The image classification function may be configured to detect and classify features based on information received from only a portion of the multiple available sources. For example, in the case that the captured visual camera data includes images that may be blurred, the system 250 may identify objects based on data from one or more of the other systems (e.g., LiDAR system 222) that does not include the image data.

The computer vision function may be configured to process and analyze images captured by the camera system 220 and/or the LiDAR system 222 or stored on one or more modules of the autonomy system 250 (e.g., in the memory 214), to identify objects and/or features in the environment surrounding the truck 200 (e.g., lane lines). The computer vision function may use, for example, an object recognition algorithm, video tracing, one or more photogrammetric range imaging techniques (e.g., a structure from motion (SfM) algorithms), or other computer vision techniques. The computer vision function may be configured to, for example, perform environmental mapping and/or track object vectors (e.g., speed and direction). For example, objects or features may be classified into various object classes using the image classification function, for instance, and the computer vision function may track the one or more classified objects to determine aspects of the classified object (e.g., aspects of its motion, size, etc.). The computer vision function may be embodied by a software module (e.g., the object detection and classification module 230) that may be communicatively coupled to a repository of images or image data (e.g., visual data and/or point cloud data), and may additionally implement the functionality of the image classification function.

Mapping/localization module 204 receives perception data that can be compared to one or more digital maps stored in the mapping/localization module 204 to determine where the truck 200 is in the world and/or or where the truck 200 is on the digital map(s). In particular, the mapping/localization module 204 may receive perception data from the perception module 202 and/or from the various sensors sensing the environment surrounding the truck 200, and May correlate features of the sensed environment with details (e.g., digital representations of the features of the sensed environment) on the one or more digital maps. The digital map may have various levels of detail and can be, for example, a raster map, a vector map, etc. The digital maps may be stored locally on the truck 200 and/or stored and accessed remotely. In some instances, the truck 200 deploys with sufficiently stored information in one or more digital map files to complete a mission without connection to an external network during the mission. A centralized mapping system may be accessible via network 260 for updating the digital map(s) of the mapping/localization module 204. The digital map may be built through repeated observations of the operating environment using the truck 200 and/or trucks or other vehicles with similar functionality. For instance, the truck 200, a specialized mapping vehicle, a standard autonomous vehicle, or another vehicle, can run a route several times and collect the location of all targeted map features relative to the position of the vehicle conducting the map generation and correlation. These repeated observations can be averaged together in a known way to produce a highly accurate, high-fidelity digital map. This generated digital map can be provided to each vehicle (e.g., from the network 260 to the truck 200) before the vehicle departs on its mission so it can carry it onboard and use it within its mapping/localization module 204. Hence, the truck 200 and other vehicles (e.g., a fleet of trucks similar to the truck 200) can generate, maintain (e.g., update), and use their own generated maps when conducting a mission.

The generated digital map may include an assigned confidence score assigned to all or some of the individual digital feature representing a feature in the real world. The confidence score may be meant to express the level of confidence that the position of the element reflects the real-time position of that element in the current physical environment. Upon map creation, after appropriate verification of the map (e.g., running a similar route multiple times such that a given feature is detected, classified, and localized multiple times), the confidence score of each element will be very high, possibly the highest possible score within permissible bounds.

The vehicle control module 206 may control the behavior and maneuvers of the truck. For example, once the systems on the truck have determined its location with respect to map features (e.g., intersections, road signs, lane lines, etc.) the truck may use the vehicle control module 206 and its associated systems to plan and execute maneuvers and/or routes with respect to the features of the environment. The vehicle control module 206 may make decisions about how the truck will move through the environment to get to its goal or destination as it completes its mission. The vehicle control module 206 may consume information from the perception module 202 and the maps/localization module 204 to know where it is relative to the surrounding environment and what other traffic actors are doing.

The vehicle control module 206 may be communicatively and operatively coupled to a plurality of vehicle operating systems and may execute one or more control signals and/or schemes to control operation of the one or more operating systems, for example, the vehicle control module 206 may control one or more of a vehicle steering system, a propulsion system, and/or a braking system. The propulsion system may be configured to provide powered motion for the truck and may include, for example, an engine/motor, an energy source, a transmission, and wheels/tires and may be coupled to and receive a signal from a throttle system, for example, which may be any combination of mechanisms configured to control the operating speed and acceleration of the engine/motor and thus, the speed/acceleration of the truck. The steering system may be any combination of mechanisms configured to adjust the heading or direction of the truck. The brake system may be, for example, any combination of mechanisms configured to decelerate the truck (e.g., friction braking system, regenerative braking system, etc.) The vehicle control module 206 may be configured to avoid obstacles in the environment surrounding the truck and may be configured to use one or more system inputs to identify, evaluate, and modify a vehicle trajectory. The vehicle control module 206 is depicted as a single module, but can be any combination of software agents and/or hardware modules able to generate vehicle control signals operative to monitor systems and control various vehicle actuators. The vehicle control module 206 may include a steering controller and for vehicle lateral motion control and a propulsion and braking controller for vehicle longitudinal motion.

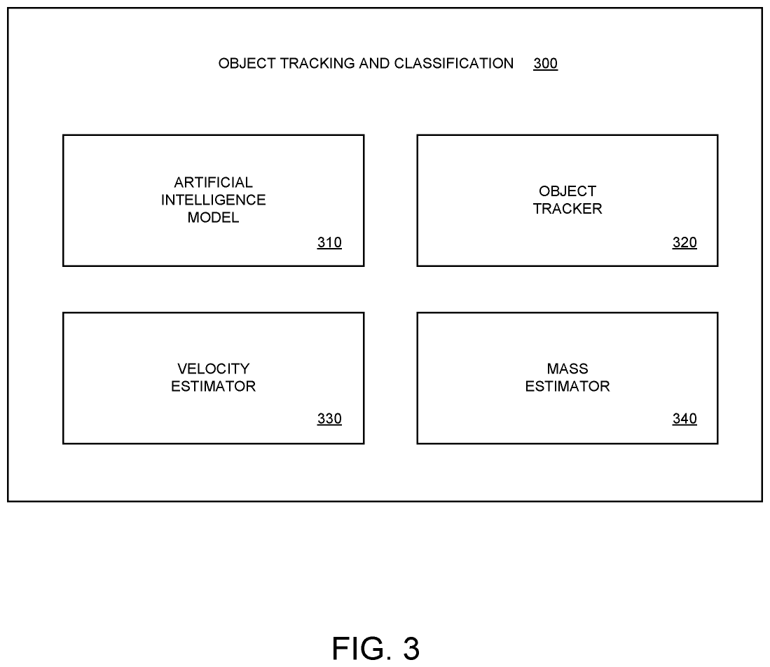

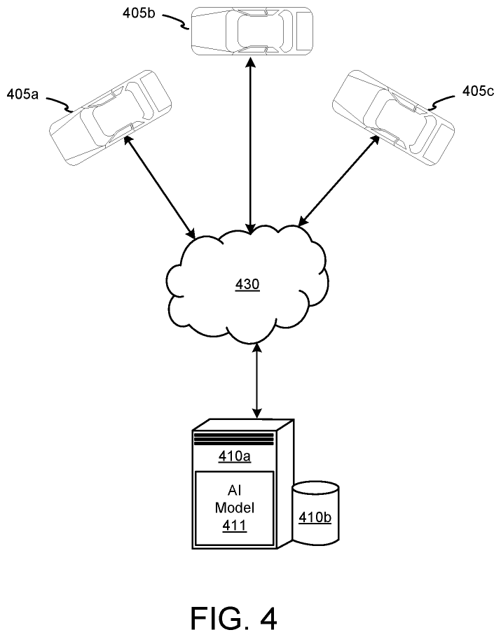

FIG. 3 shows an object tracking and classification module 300 of system 100, 250. Object tracking and classification module 300 includes artificial intelligence model 310, object tracker 320, velocity estimator 330, and effective mass estimator 340. These components of object detecting and tracking module 300 may be either or both software-based components and hardware-based components. For example, one or more components of the object tracking and classification module 300 may be stored and executed by a remote server (e.g., remote server 170 of FIG. 1, remote server 270 of FIG. 2, remote server 410a of FIG. 4, etc.).

For instance, object tracking and classification module 230, 300 executes the artificial intelligence model 310 to detect and classify objects in sequences of images captured by at least one sensor (e.g., a camera, a video camera or video streaming device, etc.) of the autonomous vehicle. In some implementations, the artificial intelligence model 310 can be executed in response to receiving an image from at least one sensor of the autonomous vehicle. The artificial intelligence model 310 can be or may include one or more neural networks. The artificial intelligence model 310 can be a single shot multi-box detector, and can process an entire input image in one forward pass. Processing the entire input image in one forward pass improves processing efficiency, and enables the artificial intelligence model 310 to be utilized for real-time or near real-time autonomous driving tasks.

For example, the input to the artificial intelligence model 310 may be pre-processed, or the artificial intelligence model 310 itself may perform additional processing on the input data. For example, an input image to the artificial intelligence model 310 can be divided into a grid of cells of a configurable (e.g., based on the architecture of the artificial intelligence model 310) size. The artificial intelligence model 310 can generate a respective prediction (e.g., classification, object location, object size/bounding box, etc.) for each cell extracted from the input image. As such, each cell can correspond to a respective prediction, presence, and location of an object within its respective area of the input image. The artificial intelligence model 310 may also generate one or more respective confidence values indicating a level of confidence that the predictions are correct. If an object represented in the image spans multiple cells, the cell with the highest prediction confidence can be utilized to detect the object. The artificial intelligence model 310 can output bounding boxes and class probabilities for each cell, or may output a single bounding box and class probability determined based on the bounding boxes and class probabilities for each cell. For example, the class and bounding box predictions are processed by non-maximum suppression and thresholding to produce final output predictions.

The artificial intelligence model 310 may be or may include a deep convolutional neural network (CNN), which may include one or more layers that may implement machine-learning functionality. The one or more layers can include, in a non-limiting example, convolutional layers, max-pooling layers, activation layers and fully connected layers, among others. Convolutional layers can extract features from the input image (or input cell) using convolution operations. The convolutional layers can be followed, for example, by activation functions (e.g., a rectified linear activation unit (ReLU) activation function, exponential linear unit (ELU) activation function, etc.), model. The convolutional layers can be trained to process a hierarchical representation of the input image, where lower level features are combined to form higher-level features that may be utilized by subsequent layers in the artificial intelligence model 310.

The artificial intelligence model 310 may include one or more max-pooling layers, which may down-sample the feature maps produced by the convolutional layers, for example. The max-pooling operation can replace the maximum value of a set of pixels in a feature map with a single value. Max-pooling layers can reduce the dimensionality of data represented in the artificial intelligence model 310. The artificial intelligence model 310 may include multiple sets of convolutional layers followed by a max-pooling layer, with the max-pooling layer providing its output to the next set of convolutional layers in the artificial intelligence model. The artificial intelligence model 310 can include one or more fully connected layers, which may receive the output of one or more max-pooling layers, for example, and generate predictions as described herein. A fully connected layer may include multiple neurons, which perform a dot product between the input to the layer and a set of trainable weights, followed by an activation function. Each neuron each neuron in a fully connected layer can be connected to all neurons or all input data of the previous layer. The activation function can be, for example, a sigmoid activation function that produces class probabilities for each object class for which the artificial intelligence model is trained. The fully connected layers may also predict the bounding box coordinates for each object detected in the input image.

The artificial intelligence model 310 may include or may utilize one or more anchor boxes to improve the accuracy of its predictions. Anchor boxes can include predetermined boxes with different aspect ratios that are used as references for final object detection predictions. The artificial intelligence model 310 can utilize anchor boxes to ensure that the bounding boxes it outputs have the correct aspect ratios for the objects they are detecting. The predetermined anchor boxes may be pre-defined or selected based on prior knowledge of the aspect ratios of objects that the model will encounter in the images captured by the sensors of autonomous vehicles. The size and aspect ratios of anchor boxes can be can determined based on statistical analysis of the aspect ratios of objects in a training dataset, for example. The anchor boxes may remain fixed in size and aspect ratio during both training and inference, and may be chosen to be representative of the objects in the target dataset.

The artificial intelligence model 310 may be trained at one or more remote servers (e.g., the remote server 170, the remote server 270, the remote server 410a, etc.) using any suitable machine-learning training technique, including supervised learning, semi-supervised learning, self-supervised learning, or unsupervised learning, among other techniques. In an example training process, the artificial intelligence model 310 can be trained using a set of training data that includes images of objects and corresponding ground truth data specifying the bounding boxes and classifications for those objects. The images used in the training data may be received from autonomous vehicles described herein, and the ground-truth values may be user-generated through observations and experience to facilitate supervised learning. For example, the training data may be pre-processed via any suitable data augmentation approach (e.g., normalization, encoding, any combination thereof, etc.) to produce a new dataset with modified properties to improve model generalization using ground truth.

The object tracker 320 may track objects detected in the sequences of images by the artificial intelligence model 310. The object tracker 320 may perform environmental mapping and/or track object vectors (e.g., speed and direction). Objects or features may be classified into various object classes using the image classification function, for instance, and the computer vision function may track the one or more classified objects to determine aspects of the classified object (e.g., aspects of its motion, size, etc.). To do so, the object tracker 320 may execute a discriminative correlation filter tracker with channel and spatial reliability of tracker (CSRT) to predict a position and size of a bounding box in a second image given a first image (and corresponding bounding box) as input. For example, the object tracker 320 may utilize alternative tracking algorithms, including but not limiting to Boosting, Multiple Instance Learning (MIL), or Kernelized Correlation Filter (KCF), among others.

The object tracker 320 can determine that an object has been detected in a first image of a sequence of images captured by the sensors of the autonomous vehicle. If the object has not appeared in any previous images (e.g., a tracking process has failed to associate the object with a previously tracked object in previous images), the object tracker 320 can generate a tracking identifier for the object, and begin a new tracking process for the object in the first image and subsequent images in the sequence of images. The object tracker 320 can utilize the CSRT algorithm to learn a set of correlated filters that represent detected object and its appearance in the first image, and update these filters in each subsequent image to track the object in the subsequent images. The correlation between the filters and the image is maximized to ensure that the object is accurately located in each image, while the correlation with the background is minimized to reduce false positive detections. In each subsequent incoming image (e.g., as is it captured, or as the object tracker 320 iterates through a previously captured sequence of images, etc.), the object tracker 320 can output the predicted position and size of a bounding box for the object in the subsequent image, and compare the predicted bounding box with the actual bounding box (e.g., generated by the artificial intelligence model 310) in the subsequent image.

The object tracker 320 can associate the newly detected object with the generated tracking identifier if the Intersection over Union (IOU) of the predicted bounding box and the actual bounding box is greater than a predetermined value. The object tracker 320 can calculate the IOU as the ratio of the area of the intersection of two bounding boxes to the area of their union. To calculate the IOU, the object tracker 320 can determine the coordinates of the top-left and bottom-right corners of the overlapping region between the two bounding boxes (e.g., by subtracting determined coordinates of each bounding box). Then, the object tracker 320 can calculate the width and height of the overlap and utilize the width and height to calculate the area of the overlap. The object tracker 320 can calculate the area of union as the sum of the areas of the two bounding boxes minus the area of their overlap, and then calculate the IOU as the ratio of the area of intersection to the area of the union.

In some implementations, the object tracker 320 can utilize the Kuhn-Munkres algorithm to perform matching of bounding boxes to existing tracking identifiers. The Kuhn-Munkres algorithm can be utilized to find the optimal assignment between the predicted bounding boxes and the detected bounding boxes that minimizes the sum of the costs (or maximizes the negation of the costs) associated with each assignment. The cost of an assignment may be for example, the IOU between the bounding boxes, or in some implementations, the Euclidean distance between the centers of the bounding boxes. When executing the Kuhn-Munkres algorithm, the object tracker 320 can create a cost matrix (or other similar data structure). Each element of the matrix can represent the cost of assigning a predicted bounding box to a detected bounding box. The cost matrix may represent a bipartite graph (e.g., an adjacency matrix with each edge indicated as a cost). The object tracker 320 can determine the optimal assignment (e.g., the tracking identifier to associate with the detected bounding boxes) by optimizing for the maximum sum of the negation of the cost matrix for the pairs of bounding boxes (e.g., a maximum weight matching for the weighted bipartite graph).

In some implementations, the object tracker 320 can execute the Kuhn-Munkres algorithm to determine the best matching pairs within the bipartite graph. To do so, the object tracker 320 can assign each node in the bipartite graph a value that represents the best case of matching in the bipartite graph. For any two connected nodes in the bipartite graph, that the assigned value of two nodes is larger or equal to the edge weight. In this example, each node in the bipartite graph represents a predicted bounding box or a detected bounding box, and the predicting bounding boxes can only match to the detected bounding boxes, or vice versa. In some implementations, the values can be assigned to each of the nodes representing predicted bounding boxes, and the node value of the nodes in the bipartite graph that represent detected bounding boxes can be assigned to a node value of zero.

When executing the Kuhn-Munkres algorithm, the object tracker 320 can continuously iterate through each of the nodes in the bipartite graph determined for the cost matrix to identify an augmenting path starting from unmatched edges at the node and ending in another unmatched edge. The object tracker 320 can take the negation of the augmenting path, to identify one or more matching nodes. In some cases, when executing the Kuhn-Munkres algorithm, the object tracker 320 may be unable to resolve a perfect match through negation of the augmenting path. For the unsuccessful augmenting path, the object tracker 320 can identify all the related nodes (e.g., nodes corresponding to predicted bounding boxes) and calculate a minimum amount by which to decrease their respective node value to match with their second candidate (e.g., a node representing a corresponding detected bounding box). In order to keep the sum of linked nodes the same, the amount by which the node values are increased can be added to nodes to which said nodes are matched. In some implementations, the Kuhn-Munkres algorithm can be executed when the number of predicted bounding boxes and the number of detected bounding boxes is the same. If the number of predicted bounding boxes and the number of detected bounding boxes is different, the object tracker 320 can generate placeholder data representing fake bounding boxes to satisfy the requirements of the Kuhn-Munkres algorithm.

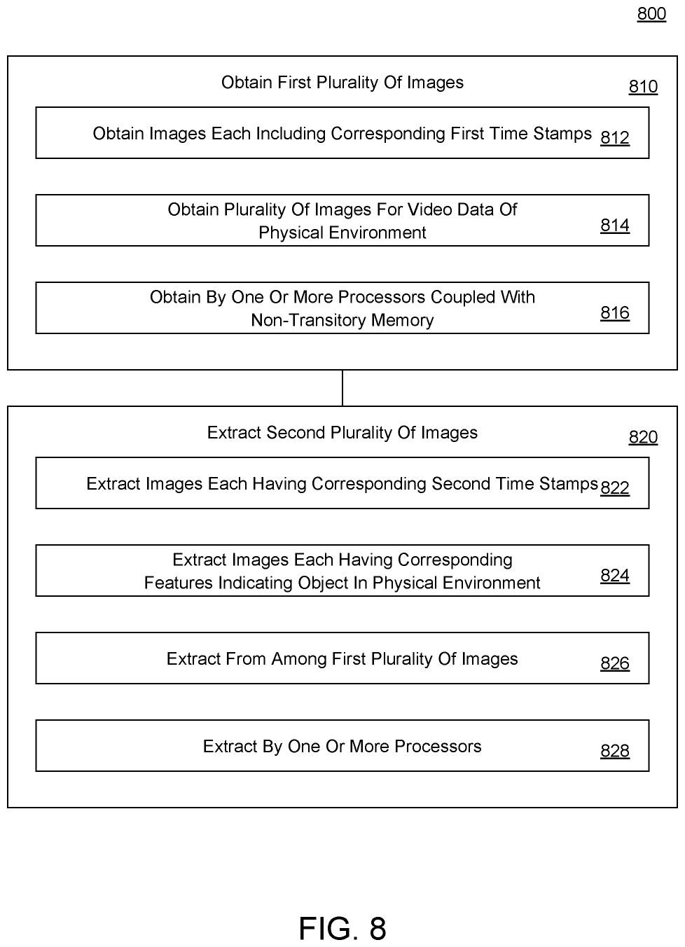

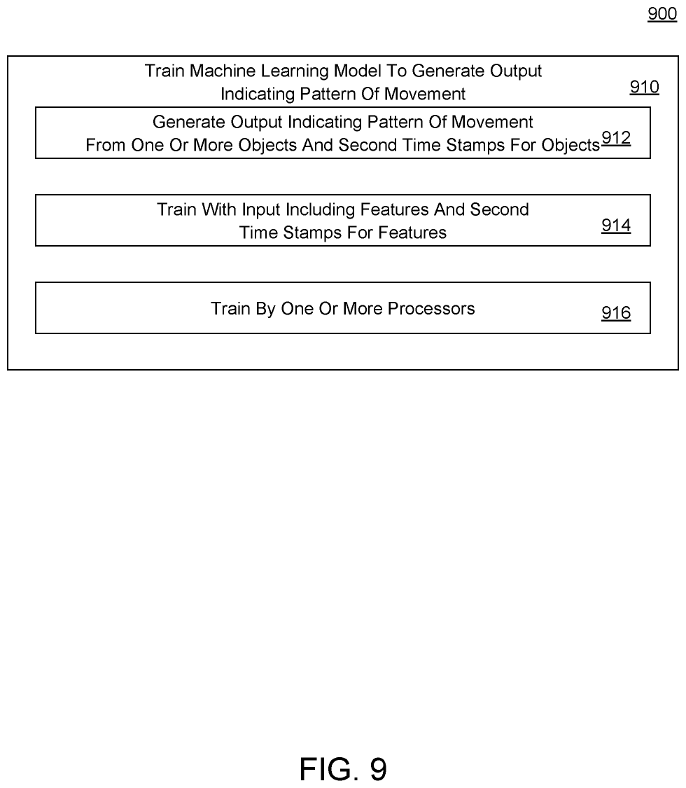

In some implementations, the object tracker 320 can implement an occlusion strategy, which handles cases where tracking fails for two or more consecutive images. One occlusion strategy is to delete or remove the tracking identifier when an object fails to appear (or be correctly tracked) in a subsequent image in the sequence of images. Another occlusion strategy is to only delete the tracking identifier if an object has failed to be tracked for a predetermined number of images (e.g., two consecutive images, five consecutive images, ten consecutive images, etc.). This can enable the object tracker 320 to correctly detect and track objects even in cases where the artificial intelligence model 310 fails to detect an object that is present in the sequence of images for one or more consecutive images. The object tracker 320 may also execute one or more of the operations described in connection with FIGS. 8 and 9 to determine a correction to a classification of objects detected in the sequence of images.

Velocity estimator 330 may determine the relative velocity of target objects relative to the ego vehicle. Effective mass estimator 340 may estimate effective mass of target objects, e.g., based on object visual parameters signals from an object visual parameters component and object classification signals from a target object classification component. The object visual parameters component may determine visual parameters of a target object such as size, shape, visual cues and other visual features in response to visual sensor signals, and generates an object visual parameters signal. The target object classification component may determine a classification of a target object using information contained within the object visual parameters signal, which may be correlated to various objects, and generates an object classification signal. For instance, the target object classification component can determine whether the target object is a plastic traffic cone or an animal.

In some implementations, the object tracking and classification module 300 may include a cost analysis function module. The cost analysis function module may receive inputs from other components of object tracking and classification module 300 and generates a collision-aware cost function. The system 100, 250 may apply this collision-aware cost function in conjunction with other functions used in path planning. For example, the cost analysis function module can provide a cost map that yields a path that has appropriate margins between the autonomous vehicle and surrounding target objects.

Objects that may be detected and analyzed by the object tracking and classification module 300 include moving objects such as other vehicles, pedestrians, and cyclists in the proximal driving area. Target objects may include fixed objects such as obstacles; infrastructure objects such as rigid poles, guardrails or other traffic barriers; and parked cars. Fixed objects, also herein referred to herein as static objects and non-moving objects can be infrastructure objects as well as temporarily static objects such as parked cars. Externally-facing sensors may provide system 100, 250 (and the object tracking and classification module 300) with data defining distances between the ego vehicle and target objects in the vicinity of the ego vehicle, and with data defining direction of target objects from the ego vehicle. Such distances can be defined as distances from sensors, or sensors can process the data to generate distances from the center of mass or other portion of the ego vehicle.

The system 100, 250 collects data on target objects within a predetermined region of interest (ROI) in proximity to the ego vehicle. Objects within the ROI satisfy predetermined criteria for likelihood of collision with the ego vehicle. The ROI may also be referred to herein as a region of collision proximity to the ego vehicle. The ROI may be defined with reference to parameters of the vehicle control module 206 in planning and executing maneuvers and/or routes with respect to the features of the environment. In some examples, there may be more than one ROI in different states of the system 100, 250 in planning and executing maneuvers and/or routes with respect to the features of the environment, such as a narrower ROI and a broader ROI. For example, the ROI may incorporate data from a lane detection algorithm and may include locations within a lane. The ROI may include locations that may enter the ego vehicle's drive path in the event of crossing lanes, accessing a road junction, swerve maneuvers, or other maneuvers or routes of the ego vehicle. For example, the ROI may include other lanes travelling in the same direction, lanes of opposing traffic, edges of a roadway, road junctions, and other road locations in collision proximity to the ego vehicle.

FIG. 4 illustrates components a system 400 for training artificial intelligence models with improved accuracy using image data, in accordance with present implementations. The system 400 may include a remote server 410a, system database 410b, artificial intelligence models 411, and autonomous vehicles 405a-d (collectively or individually the autonomous vehicle(s) 405). For example, the system 400 may include one or more administrative computing devices that may be utilized to communicate with and configure various settings, parameters, or controls of the system 100. Various components depicted in FIG. 4 may be implemented to receive and process images captured by the autonomous vehicles 405 to train the artificial intelligence models 411, which can subsequently be deployed to the autonomous vehicles 405 to assist with autonomous navigation processes. The above-mentioned components may be connected to each other through a network 430. Examples of the network 430 may include, but are not limited to, private or public local-area-networks (LAN), wireless LAN (WLAN) networks, metropolitan area networks (MAN), wide-area networks (WAN), cellular communication networks, and the Internet. The network 430 may include wired and/or wireless communications according to one or more standards and/or via one or more transport mediums.

The system 400 is not confined to the components described herein and may include additional or other components, not shown for brevity, which are to be considered within the scope of the examples described herein.

The communication over the network 430 may be performed in accordance with various communication protocols such as Transmission Control Protocol and Internet Protocol (TCP/IP), User Datagram Protocol (UDP), and IEEE communication protocols. In one example, the network 430 may include wireless communications according to Bluetooth specification sets or another standard or proprietary wireless communication protocol. In another example, the network 430 may also include communications over a cellular network, including, e.g., a GSM (Global System for Mobile Communications), CDMA (Code Division Multiple Access), EDGE (Enhanced Data for Global Evolution) network.

The autonomous vehicles 405 may be similar to, and include any of the structure and functionality of, the autonomous truck 102 of FIG. 1. The autonomous vehicles 405 may include one or more sensors, communication interfaces or devices, and autonomy systems (e.g., the autonomy system 150 or the autonomy system 250, etc.). The autonomy systems of the autonomous vehicles 405 may include an object detection and tracking module (e.g., the object detection and tracking module 300 of FIG. 3). Each autonomous vehicles 405 can transmit sensor data and any data generated or processed by the autonomy system of the autonomous vehicle 405 to the remote server 410a. The autonomous vehicles 405 may transmit the information as the autonomous vehicle 405 operates, or after the autonomous vehicle 405 has ceased operation (e.g., parked, connected to a predetermined wireless or wired network, etc.).

The remote server 410a may receive sequences of images captured during operation of the autonomous vehicles 405, and perform the correction techniques described herein to generate data for training the artificial intelligence models 411. For example, the remote server 410a can include, or implement any of the functionality of, the object detection and tracking module 300 of FIG. 3. For example, the remote server 410a may receive sequences of images received from the autonomous vehicles 405a, and store the sequences of images in the system database 110b. The remote server 410a can store the sequences of images in association with metadata received from or generated based on communications with the autonomous vehicles 405. The metadata may include, for example, an identifier of autonomous vehicle 405, a timestamp corresponding to one or of the images or the sequence of images, bounding boxes detected by the autonomy system 250 of the autonomous vehicle 405, classifications determined by the autonomy system 250 of the autonomous vehicle 405, tracking identifiers corresponding to detected bounding boxes, distance information for detected objects in the sequences of images, any sensor data described herein, among other metadata.

The remote server 410a can implement the functionality described in connection with FIG. 5 to determine one or more corrections to classifications generated by the autonomous vehicles 405. The corrections can be utilized as additional ground truth data for training the artificial intelligence model, which can be generated by the remote server 410a and stored in the system database 410b. The corrections can be determined, as described herein, by utilizing tracking information (e.g., the tracking identifiers and the bounding boxes to which they correspond) associated with objects depicted in sequences of images. The remote server 410a can determine that a classification of a tracked object in an image may not match other classifications within the sequence of images. The remote server 410a can perform a voting algorithm using the classifications corresponding to the detected object in each image of a sequence of images in which the object was detected and tracked (e.g., associated with a common tracking identifier).

In some implementations, the remote server 410a can utilize a majority-voting algorithm, in which the classification that occurs most common in the corresponding images is chosen as the corrected classification. In some implementations, the remote server 410a can utilize a normalized weighted voting algorithm. When executing the normalized weighted voting algorithm, the remote server 410a can divide the instances in which the object was detected in the sequence of images groups according to the distance of the object from the autonomous vehicle 405 that captured the sequence of images. The distance can be determined by the autonomous vehicle 405 or the remote server 410a based sensor data captured by the sensors of the autonomous vehicle 405. The remote server 410a can determine a weight value for each group, corresponding to the classification accuracy at different predetermined distances, for example. The remote server 410a can determine a candidate class label based on confidence values (e.g., generated by the artificial intelligence model that detected the bounding box in the sequence of images) associated with the detected bounding box or classification. The remote server 410a can determine a weight value for the candidate class label of each group based on a distance coefficient for the respective group. The remote server 410a can calculate the weighted sum of class confidence to determine the voted class label among the groups. In some examples, the distance coefficient is a hyper parameter, which can be tuned according to the classification performance of the various artificial intelligence models described herein (e.g., the artificial intelligence model 310) at different distance ranges.

In some implementations, the remote server 410a can detect one or more images in a consecutive sequence of images in which detection of an object (e.g., generation of an accurate bounding box) has failed. For example, the remote server 410a can iterate through a sequence of images and identify whether bounding boxes corresponding to a common tracking identifier appear in consecutive images. If an image between two images is missing a bounding box for the common tracking identifier of an object, the remote server 410a can determine that the respective bounding box is missing. The remote server 410a can generate a corrected bounding box by estimating the position and size of the bounding box for the image. To do so, the remote server 410a can execute the CSRT tracking algorithm to estimate the position and position and size of a bounding box for the object in the image given the previous image in the sequence in which the object was correctly detected.

The artificial intelligence models 411 may be stored in the system database 410b and may include artificial intelligence models that can detect and classify objects and images. For example, the artificial intelligence models 411 can include the artificial intelligence model 310 of FIG. 3 for one or more autonomous vehicles 405. In some implementations, the artificial intelligence models 411 may be generated or trained for on different types of cameras, autonomous vehicles 405, or environments. For example, the artificial intelligence models 411 may include multiple artificial intelligence models, each of which may be trained for a specific type of autonomous vehicle 405, a specific set of sensors deployed on an autonomous vehicle 405, or a particular environment in which one or more autonomous vehicles 405 may be deployed. One or more of the artificial intelligence models 411 may be derived from a similar base model, which may be fine-tuned for particular applications.

The artificial intelligence models 411 can be or may include one or more neural networks. For example, the artificial intelligence models 411 can be a single shot multi-box detector, and can process an entire input image in one forward pass. Processing the entire input image in one forward pass improves processing efficiency, and enables the artificial intelligence models 411 to be utilized for real-time or near real-time autonomous driving tasks. For example, the input to the artificial intelligence models 411 may be pre-processed, or the artificial intelligence models 411 itself may perform additional processing on the input data. For example, an input image to the artificial intelligence models 411 can be divided into a grid of cells of a configurable (e.g., based on the architecture of the artificial intelligence models 411) size. The artificial intelligence models 411 can generate a respective prediction (e.g., classification, object location, object size/bounding box, etc.) for each cell extracted from the input image. As such, each cell can correspond to a respective prediction, presence, and location of an object within its respective area of the input image.

The artificial intelligence models 411 may also generate one or more respective confidence values indicating a level of confidence that the predictions are correct. If an object represented in the image spans multiple cells, the cell with the highest prediction confidence can be utilized to detect the object. The artificial intelligence models 411 can output bounding boxes and class probabilities for each cell, or may output a single bounding box and class probability determined based on the bounding boxes and class probabilities for each cell. For example, the class and bounding box predictions are processed by non-maximum suppression and thresholding to produce final output predictions. The artificial intelligence models 411 may be or may include a deep CNN, which may include one or more layers that may implement machine-learning functionality. The one or more layers can include, in a non-limiting example, convolutional layers, max-pooling layers, activation layers and fully connected layers, among others.

The remote server 410a can train one or more of the artificial intelligence models 411 using training data stored in the system database 410b. In an example training process, the artificial intelligence models 411 can be trained using a set of training data that includes images of objects and corresponding ground truth data specifying the bounding boxes and classifications for those objects. The images used in the training data may be received from the autonomous vehicles 405, and the ground-truth values may be user-generated through observations and experience to facilitate supervised learning. For example, at least a portion of the ground truth data can be generated by the remote server 410a using the correction techniques described herein. The training data may also be pre-processed via any suitable data augmentation approach (e.g., normalization, encoding, any combination thereof, etc.) to produce a dataset with modified properties to improve model generalization using the ground truth.

The remote server 410a can train an artificial intelligence model 411, for example, by performing supervised learning techniques to adjust the parameters of the artificial intelligence model 411 based on a loss computed from the output generated by the artificial intelligence model 411 and ground truth data corresponding to the input provided to the artificial intelligence model 411. Inputs to the artificial intelligence model 411 may include images or sequences of images captured during operation of autonomous vehicles 405, and stored in the system database 110b. The artificial intelligence model 411 may be trained on a portion of the training data using a suitable optimization algorithm, such as stochastic gradient descent. The remote server 410a can train the artificial intelligence model 411 by minimizing the calculated loss function by iteratively updating the trainable parameters of the artificial intelligence model 411 (e.g., using backpropagation, etc.). The remote server 410a can evaluate the artificial intelligence model 411 on a held-out portion of the training data (e.g., validation set that was not used to train the artificial intelligence model 411) to assess the performance of the artificial intelligence model 411 on unseen data. The evaluation metrics used to assess the model's performance may include accuracy, precision, recall, and F1 score, among others.

The remote server 410a can train an artificial intelligence model 411 until a training termination condition is met. Some non-limiting training termination conditions include a maximum number of iterations being met or a predetermined performance threshold being met. The performance threshold can be satisfied when the artificial intelligence model 411 reaches a certain level of accuracy, F1 score, precision, recall, or any other relevant metric on a validation set. The remote server 410 can provide the trained artificial intelligence model 411 one or more autonomous vehicles 405 for which the artificial intelligence model 411 was trained. The autonomous vehicle(s) 405 can then utilize the artificial intelligence model 411 to detect and classify objects in real-time or near real-time, as described herein.

The remote server 410a can update one or more of the artificial intelligence models 411 (e.g., by retraining, fine-tuning, or other types of training processes) when sequences of images are received from the autonomous vehicles 405 and utilized to produce additional training data. The remote server 410a (or the autonomy systems of the autonomous vehicles 405) can generate the additional training data by determining corrections to classifications made by the artificial intelligence model executing on the autonomous vehicle. The corrected classifications and bounding boxes can be utilized as ground truth data for the images in the sequences of images to which they correspond. Further details of the correction and training process are described in connection with FIG. 5. Although the artificial intelligence models 411 can include neural networks trained using supervised learning techniques, it should be understood that any alternative and/or additional machine learning model(s) may be used to implement similar learning engines.

FIG. 5A depicts an example video content architecture, in accordance with present implementations. As illustrated by way of example in FIG. 5A, an example video content architecture 500A can include at least a time range 502, and a video data 510A.

The time range 502 can correspond to the duration of video data of the video content architecture (e.g., video data 510A). For example, the time range 502 can correspond to a plurality of time stamps associated with the video data 510A. For example, the time range 502 can correspond to the period of time beginning with a first, or earliest, time stamp of the first image in the video data 510A until a final, or latest, time stamp of the last image of the video data 510A. In some examples, the time range 502 can include a sequentially ordered plurality of timestamps (e.g., the plurality of timestamps corresponding to the images in the video data 510A).

The video data 510A can include a plurality of images (e.g., a plurality of images, including an image for each ‘cell’ of the video data 510A including, but not limited to, images 520, 522, 524, 526, 530, 534, 536, and 538) depicting the physical environment of an autonomous vehicle and including a plurality of timestamps associated with the plurality of images, each of the timestamps corresponding to one of the images of the video data 510A (e.g., a plurality of images and their corresponding timestamps). For example, the plurality of images may depict one or more vehicles (e.g., vehicle 540) that are physically present in the same roadway as (e.g., in front of) an autonomous vehicle. In some examples, and as described further below, the video data 510A can include a plurality of images that are categorized as keyframes of the video data 510A, which can comprise a portion, or subset, of the plurality of images included in the video data 510A (e.g., images 520, 522, 524, 526, 530, 534, 536, and 538).

FIG. 5B depicts an example segmented video content architecture, in accordance with present implementations. As illustrated by way of example in FIG. 5B, an example segmented video content architecture 500B can include at least a first time segment 504, a second time segment 506, and a third time segment 508.

The first time segment 504 can correspond to a first portion of the video data 510B for one or more events that have been detected in the physical environment of an autonomous vehicle, as depicted in the video data 510B, and which occur over at least part of the time range 502. For example, the first time segment 504 can correspond to a portion of the video data 510B that depicts an acceleration of the vehicle 540 and a lateral movement of the vehicle 540 (e.g., two events), which is captured in the images 520, 522, and 524. In some examples, the timestamps of the images associated with an event may be used to determine the duration of a time segment (e.g., the first time segment 504) corresponding to that event. Accordingly, in some examples, the first time segment 504 can correspond to, or be defined by, one or more keyframes, or a subset of images, of the video data 510B, which capture, or are associated with, one or more events of the first time segment (e.g., to create the first time segment 504).

The second time segment 506 can correspond to a second portion of the video data 510B for one or more second events, which occurs after the first event within the physical environment as depicted in the video data 510B. For example, the second time segment 506 can correspond to a portion of the video data 510B that depicts a drift, or horizontal movement, of the vehicle 540 from the right lane of the roadway (e.g., the position of the vehicle 540 shown in image 526) to the center of the roadway (e.g., the position of the vehicle 540 shown in image 532)). In some examples, the second time segment 506 can correspond to one or more keyframes, or images of the video data 510B, which may define the second event, or create the second time segment 506, which corresponds to the second portion (e.g., a second plurality of images with their corresponding time stamps) of the video data 510B during that portion of the time range 502.

The third time segment 508 can correspond to a third portion of the video data 510B for one or more events occurring after the one or more events of the first and second time segments 504 and 506 within the physical environment of the autonomous vehicle and that is captured in the third portion of the video data 510B. For example, the third time segment 508 can correspond to a portion of the video data 510B that depicts a lane change, or horizontal movement, of the vehicle 540 from the right lane of the roadway (e.g., the position of the vehicle 540 in image 534), across the center of the roadway (e.g., the position of the vehicle 540 in image 536), and finally to the left lane of the roadway (e.g., the position of the vehicle 540 in image 538). In some examples, the third time segment 508 can correspond to one or more keyframes, or images of the video data 510B, which may be used to determine the third event and create the third time segment 508 (including to determine the duration of the third time segment 508), which corresponds to the third portion of the video data 510B characterized by the one or more keyframes of the third time segment (e.g., a third plurality of images that includes images 534, 536, and 538 and their corresponding time stamps).

FIG. 6A depicts an example multi-feature video content architecture, in accordance with present implementations. As illustrated by way of example in FIG. 6A, an example multi-feature video content architecture 600A can include at least a video data 610A.

The video data 610A can include a plurality of images (e.g., a plurality of images, including an image for each ‘cell’ of the video data 610A including, but not limited to, images 620, 622, 624, 630, 632, 634, 640, 642, and 644) depicting the physical environment of an autonomous vehicle (e.g., a roadway and two vehicles 540 and 650 in front of an autonomous vehicle) and including a plurality of corresponding timestamps, each of the timestamps corresponding to one of the images of the video data 610A (e.g., a plurality of images and the corresponding timestamps). For example, the plurality of images may depict one or more vehicles (e.g., vehicles 540 and 650) that are physically present in the same roadway as, or are located in front of, an autonomous vehicle. In some examples, and as described further below, the video data 610A can include a subset of the plurality of images, comprising one or more keyframes of the video data 610A. In some examples, the one or more keyframes of the video data 610A can be comprised of a portion, or subset, of the plurality of images in the video data 610A (e.g., images 620, 622, 624, 630, 632, 634, 640, 642, and 644).

In some examples, the number of images included in the video data 610A is determined by the framerate used to record the video data 610A and the duration of the time period 502. For example, video data recorded using a framerate of 30 frames per second and over a time range of 15 seconds could include approximately 450 images, which can each include a corresponding timestamp and any additional metadata that may be necessary for the collection and analysis of video data 610A.

FIG. 6B depicts an example segmented multi-feature video content architecture, in accordance with present implementations. As illustrated by way of example in FIG. 6B, an example segmented multi-feature video content architecture 600B can include at least a first time segment 604, a second time segment 606, and a third time segment 608.

The first time segment 604 can correspond to a first portion of the video data 610B for one or more events that have been detected in the physical environment of an autonomous vehicle, as depicted in the video data 610B. For example, the first time segment 604 can correspond to a portion of the video data 610B that depicts various degrees of acceleration by the vehicle 540 and by the vehicle 650, including, for example, an acceleration of the vehicle 650 in response to the acceleration of the vehicle 540. For example, the various amounts of acceleration of vehicles 540 and 650 can be captured in the images 620, 622, and 624, which depict an acceleration event (e.g., of vehicles 540 and 650) based on the change in the positions of the vehicles 540 and 650 over a known amount of time (e.g., determined from the number of images between each change in position and the framerate associated with the images of the video data). In some examples, the timestamps of the images associated with one or more events may be used to determine the duration of a time segment (e.g., the first time segment 604) corresponding to those events (e.g., during which the one or more events occur). Accordingly, in some examples, the first time segment 604 can correspond to, or be defined by, one or more keyframes, or a subset of images, of the video data 610B, which capture, or are otherwise associated with, one or more events that occur during the first time segment.

The second time segment 606 can correspond to a second portion of the video data 610B for one or more events that have been detected in the physical environment of an autonomous vehicle and that are depicted in one or more images with timestamps corresponding to that portion of the video data 610B. For example, the second time segment 606 can correspond to a portion of the video data 610B that depicts various degrees of acceleration by the vehicle 540 and by the vehicle 650, including, for example, an acceleration of the vehicle 650 in response to the acceleration of the vehicle 540. For example, the second time segment can correspond to video data including images reflecting acceleration of vehicle 650 in response to one or more erratic movements of vehicle 540, and can be captured in the images 630, 632, and 634. In some examples, the timestamps of the images associated with one or more events (e.g., the events of second time segment 606) may be used to determine the duration of a time segment (e.g., the second time segment 606) corresponding to those events (e.g., the portion of time range 502 during which the one or more events occur). Accordingly, in some examples, the second time segment 606 can correspond to, or be defined by, one or more keyframes, or a subset of images, of the video data 610B, which capture, or are otherwise associated with, the one or more events that occur during the second time segment 606.

The third time segment 608 can correspond to a third portion of the video data 610B for one or more events that have been detected in the physical environment of an autonomous vehicle and that are depicted in one or more images with timestamps corresponding to the third portion of the video data 610B. For example, the third time segment 608 can correspond to a portion of the video data 610B that depicts various degrees of acceleration by the vehicle 540 and by the vehicle 650, including, for example, a change in position of the vehicle 650, which ultimately leaves the roadway (e.g., as shown in image 644) in response to the erratic movements of the vehicle 540 (e.g., positions of vehicle 540 in images 640 and 642). For example, the third time segment can correspond to video data including images reflecting a change in position of vehicle 650, which may ultimately exit the roadway in response to one or more erratic movements of vehicle 540, as shown in the images 640, 642, and 644. In some examples, the timestamps of the images associated with one or more events (e.g., the events of third time segment 608) may be used to determine the duration of a time segment (e.g., the third time segment 608) corresponding to the one or more events (e.g., the portion of time range 502 during which any of the one or more events occur). Accordingly, in some examples, the third time segment 608 can correspond to, or be defined by, one or more keyframes, or a subset of images (e.g., images 640, 642, and 644), of the video data 610B, which capture, or are otherwise associated with, the one or more events that occur during the third time segment 608.

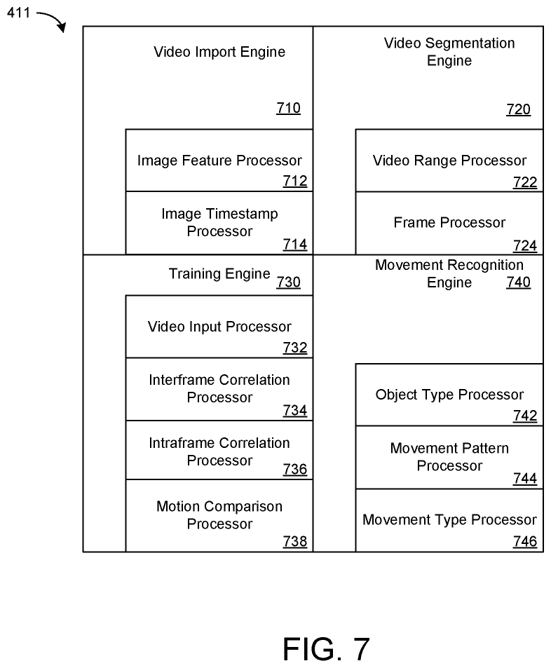

FIG. 7 depicts an example machine learning model architecture, in accordance with present implementations. As illustrated by way of example in FIG. 7, an example machine learning model architecture 700 can include at least a video import engine 710, a video segmentation engine 720, a training engine 730, and a movement recognition engine 740.

The video import engine 710 can receive and process video data (e.g., video data 510A, 510B, 610A, and 610B) to determine the plurality of images and the corresponding timestamps and one or more vehicles detected in the physical environment of an autonomous vehicle based on the received video data. The video import engine 710 can include an image feature processor 712, and an image timestamp processor 714. The image timestamp processor 714 can identify one or more images and the corresponding timestamps of the identified images from the video data received by the video import engine 710. For example, the video import engine 710 can receive video data 510A and it can identify, via the operation of image timestamp processor 714, one or more images, and one or more corresponding timestamps, from the received video data 510A (e.g., images 520, 522, 524, 526, 530, 534, 536, and 538 with their corresponding timestamps). Furthermore, the video import engine 710 can also identify, via the operation of the image feature processor 712, one or more features (e.g., the vehicle 540) in, or aspects of, the physical environment of an autonomous vehicle that is detected by, or captured in, the video data (e.g., video data 510A). The one or more features can include, for example, roadway objects, vehicles, pedestrians, cyclists, animals, and the like, such as that is captured by (e.g., detected in) a plurality of the images identified (by the image timestamp processor 714) in the received video data 510A.

In some examples, the image feature processor 712 comprises a machine learning model trained to identify one or more features of an image from the video data received by the video import engine 710. For example, the image feature processor 712 can include an artificial intelligence model trained to identify any vehicles that are present in the plurality of images comprising the video data received by the video import engine 710. For example, the feature processor 712 can execute the artificial intelligence model to detect and classify objects in sequences of images captured by, or included in, the video data received by the system 700. In some implementations, the feature processor 712 can execute the artificial intelligence model in response to receiving one or more images (e.g., included in video data) from the video import engine 710. In some examples, the artificial intelligence model of the image feature processor 712 can be or may include one or more neural networks. The artificial intelligence model can be a single shot multi-box detector, and can process an entire input image (e.g., a frame of the video data received by video import engine 710) in one forward pass. Processing the entire input image in one forward pass can improve processing efficiency, and enables the artificial intelligence model of the image feature processor 712 to be utilized for real-time or near real-time autonomous driving tasks.

In some examples, the image feature processor 712 can incorporate aspects of a deep convolutional neural network (CNN) model, which may include one or more layers that may implement machine-learning functionality for a portion of the operations performed by the image feature processor 712. The one or more layers can include, in a non-limiting example, convolutional layers, max-pooling layers, activation layers and fully connected layers, among others. Convolutional layers can extract features from the input image(s) (or input cell) of the video data using convolution operations. In some examples, the convolutional layers can be followed, for example, by activation functions (e.g., a rectified linear activation unit (ReLU) activation function, exponential linear unit (ELU) activation function, etc.), model. The convolutional layers can be trained to process a hierarchical representation of the input image, where lower level features are combined to form higher-level features that may be utilized by subsequent layers in the image feature processor 712 or the corresponding machine learning model.

The image feature processor 712 may include one or more max-pooling layers, which may down-sample the feature maps produced by the convolutional layers, for example. The max-pooling operation can replace the maximum value of a set of pixels in a feature map with a single value. Max-pooling layers can reduce the dimensionality of data represented in the image feature processor 712. The image feature processor 712 may include multiple sets of convolutional layers followed by a max-pooling layer, with the max-pooling layer providing its output to the next set of convolutional layers in the artificial intelligence model. The image feature processor 712 can include one or more fully connected layers, which may receive the output of one or more max-pooling layers, for example, and generate predictions as described herein. A fully connected layer may include multiple neurons, which perform a dot product between the input to the layer and a set of trainable weights, followed by an activation function. Each neuron each neuron in a fully connected layer can be connected to all neurons or all input data of the previous layer. The activation function can be, for example, a sigmoid activation function that produces class probabilities for each object class for which the artificial intelligence model is trained. The fully connected layers may also predict the bounding box coordinates for each object detected in the input image.

The video segmentation engine 720 can create one or more time segments for the video data received by the video import engine 710, including one or more time segments determined from the timing of one or more events associated with the received video data, or a portion thereof. For example, the video segmentation engine 720 can determine one or more time segments of the received video data (e.g., first and last timestamps of each time segment) based on the timestamps for the images used to identify the corresponding one or more events (e.g., first time segment 504 can be determined based on the timestamps of the first image in video data 510B and the timestamp of image 524). For example, the video segmentation engine 720 can include a video range processor 722, and a frame processor 724.

For example, the video segmentation engine 720 can select, based on a frame rate of the video data, a plurality of images of a time segment, where the time stamps of the plurality of images separated by a time interval corresponding to the frame rate. As another example, the video segmentation engine 720 can select, based on a predetermined time period, a second plurality of images with a difference between an earliest time stamp of the plurality of images and a latest time stamp of the plurality of images is less than or equal to a predetermined time period (e.g., 500 milliseconds, 1 second, 3 seconds, etc.).

The video range processor 722 can determine a time range of the received video data (e.g., from a timestamp of the first image of an event until the timestamp of a last image of the same event) based on the timestamps for the images included in the video data received by the video import engine 710. For example, upon receipt of video data 510A, the video range processor 722 can determine the time range 502, or total time range of the images included in the video data 510A, based on the timestamps for the images that make up the video data 510A.

The frame processor 724 can process one or more of the images, or fames, included in the video data to determine one or more time segments of the time range output by the video range processor 722. For example, the frame processor 724 can determine a minimum number of frames, or keyframes, necessary accurately depict the one or more events, scenarios, or object movements captured in a segment of the video data. For example, the frame processor 724 can determine the number of images, or frames, required for a segment of video data based on the types of object(s), the framerate of the received video data, movement (e.g., velocity, acceleration, position) data for an autonomous vehicle associated with the received video data during the corresponding time range (e.g., the speed of the vehicle that recorded the video data during the time range of the video data), a number of objects detected in the images of the video data, and the like. In some examples, the frame processor 724 can perform a framerate normalization process, which can remove one or more frames from video data with a framerate that is above a threshold. For example, the frame processor 724 can include normalizing a framerate of the video data (e.g., reducing the number of frames per second of video data) to associate each frame in the video data with a specific time step (e.g., a specific framerate or number of frames per second) having a particular granularity or below a specific threshold (e.g., below 30 frames per second, etc.). Thus, for a particular set of input video data with a 60 Hz framerate, the frame processor 724 can, as a non-limiting example, normalize the video data to have a 30 Hz framerate by removing approximately half of the images of the video data (e.g., a remove every other frame). The frame processor 724 can determine a threshold for the framerate of normalized video data based on, for example, the types of object(s) captured in the video data and/or the types of movement(s) associated with them during the video data (e.g., a higher framerate for video data of objects with erratic movements or a sudden change in speed or direction).

The training engine 730 can include a video input processor 732, an interframe correlation processor 734, and an intraframe correlation processor 736. The training engine 730 can train one or more artificial intelligence models utilized by the system 700 to determine the time segments of received video data and determine the types of, and patterns in, any associated object movement of the received video data. For example, the training engine 730 can train artificial intelligence models of the interframe correlation processor 734 and the intraframe correlation processor 736 to identify one or more events, scenarios, or movements for a time segment of video data or a portion of segmented video data. For example, the training engine 730 can train one or more artificial intelligence models to identify events for video data that can include multiple objects and, if applicable, cascading (e.g., interdependent) effects of or movement patterns for the different objects (e.g., determining that the erratic swerving movements of vehicle 540 at images 640 and 642 caused vehicle 650 to exit the roadway at image 644).

The video input processor 732 can perform additional processing on the input data (e.g., the timestamped images of the video data). For example, an input image to the video input processor 732 can be divided into a grid of cells of a configurable (e.g., based on the architecture of one or more artificial intelligence models of the interframe correlation processor 734 and intraframe correlation processor 736) size. The video input processor 732 can generate a respective prediction (e.g., classification, object location, object size/bounding box, etc.) for each cell extracted from the input image. Additionally, the video input processor 732 can use the timestamps of the input images to determine the relative timing of each image input to the video input processor 732. As such, each image, or frame, can correspond to a respective prediction, presence, and location of an object within its respective portion (e.g., timing) of the video data.

The interframe correlation processor 734 can one or more events, scenarios, or object movements, occurring across one or more of the images in a segment of video data, including scenarios based on multiple objects and, if applicable, cascading (e.g., interdependent) effects between one or more different objects. For example, the interframe correlation processor 734 can include an artificial intelligence model that is trained to determine how the movements of one object in one frame relate to the movements of the object(s) in one or more later (e.g., based on timestamps) image(s) of the video data (e.g., later images in one segment of the video data output by video segmentation engine 720). More specifically, for example, the interframe correlation processor 734 can determine whether erratic swerving of vehicle 540 (e.g., at images 640 and 642) affects the position of vehicle 650 in later frames, causing it to exit the roadway (e.g., at image 644).

The artificial intelligence model of the interframe correlation processor 734 can, for example, determine whether an event of or movement by one vehicle (e.g., vehicle 540) will affect, or is itself affected by, any other objects (e.g., vehicles) in one or more different (e.g., later) images, or frames, of the video data (e.g., other images in a segment of video data). For example, the interframe correlation processor 734 can be trained to determine that a breaking movement by a first vehicle will cause a change in position (e.g., breaking, lane change, etc.) of one or more additional vehicles in one or more different frames, or images, of the video data. The interframe correlation processor 734 can determine correlations between objects in different frames of the video data based on, for example, the position of one or more effected vehicle(s) relative to one or more correlated objects of the video data (or a segment of video data). As another example, the interframe correlation processor 734 can determine the correlation between frames for the movement of a single object in each of the frames, including, for example, that the change in position of a vehicle, occurring across multiple different frames, corresponds to a gradual lane change (e.g., from right to left) by the vehicle in the images.

The intraframe correlation processor 736 can determine one or more intraframe events, scenarios, or object movements, for the images in a segment of video data, including scenarios based on multiple objects and, if applicable, cascading (e.g., interdependent) effects between one or more different objects. For example, the intraframe correlation processor 736 can include an artificial intelligence model that is trained to determine whether the movements of one object affect the movements of any other object(s) in the same image or frame. More specifically, for example, the intraframe correlation processor can determine whether erratic swerving of vehicle 540 (e.g., at images 640 and 642) affects the position of vehicle 650 and causes it to exit the roadway (e.g., at image 644). Additionally, in some examples, the intraframe correlation processor 736 can determine a non-causal correlation between different objects in an image or frame. For example, the intraframe correlation processor 736 can determine a correlation between the position, movement, trajectory, or acceleration of two different vehicles on a roadway, as a result of strong horizontal (e.g., perpendicular to the roadway) wind or any other factor(s) that are not caused by an object in the image.

The artificial intelligence model of the intraframe correlation processor 736 can, for example, determine whether an event of or movement by one vehicle (e.g., vehicle 540) will affect, or is itself affected by, any other objects (e.g., vehicles) in the same image, or frame, from the video data. For example, the intraframe correlation processor 736 can determine that a breaking movement by a first vehicle is related to the change in position (e.g., breaking) of one or more additional vehicles based on the position of the additional vehicle(s) relative to the first vehicle. As another example, the intraframe correlation processor 736 can determine the relative positioning of one or more objects within an image (e.g., whether a first vehicle is located in front of one or more additional vehicles).

The motion comparison processor 738 can compare the predictions for the movement, trajectory, or acceleration of a vehicle produced by one or more machine learning models with the actual movement, trajectory, or acceleration measured for that vehicle. For example, the output of the comparison processor 738 can be used to identify one or more corner cases (e.g., outliers) that do not comport with one or more types of movement or movement patterns determined by the movement recognition engine 740 for one or more vehicles. Further, the motion comparison processor 738 may log (e.g., record) each identified corner case (e.g., each comparison where the predicted movement pattern differed from the actual measured movement of the corresponding vehicle), which are each added to a database (e.g., non-transitory storage medium) to use in further training of machine-learning based models for recognizing one or more movement patterns of a vehicle, evaluating the performance of one or more algorithms for predicting the movement (e.g., trajectory, acceleration, etc.) of a vehicle, and the like.

The movement recognition engine 740 can determine one or more types of movement or one or more movement patterns that are associated with one or more objects of a time segment (e.g., output by the video segmentation engine 720) of the received video data. For example, the movement recognition engine 740 can determine a swerving movement type for the movement of the vehicle 540 during the time segment 508 of the video data 510B. The movement recognition engine 740 can include an object type processor 742, a movement pattern processor 744, and a movement type processor 746.

The object type processor 742 can determine an object type for each object detected in the images of the received video data that are input to the movement recognition engine 740. For example, the object type processor 742 can determine an object type for each object (e.g., bounding box) that the image feature processor 712 identified in the image(s) input to object type processor 742. For example, the object type processor 742 may determine that the vehicles 540 and 650 are vehicle objects (e.g., determine that vehicle is the object type for each of the vehicles 540, and 650).

The movement pattern processor 744 can determine one or more movement patterns associated with an object identified in one or more images of the video data. For example, the movement pattern processor 744 can include an artificial intelligence model that is trained to determine a movement pattern based on the output(s) of the interframe correlation processor 734, the output(s) of the intraframe correlation processor 734, and the position(s) of one or more objects within the images of the video data input to the movement pattern processor 744. For example, the movement pattern processor 744 can determine that, during a segment of video data or the corresponding plurality of images, the movement of an object corresponds to a defined movement pattern, such as, breaking, accelerating, changing lanes, stopping, turning, swerving or other erratic movements, and the like. Additionally, the movement pattern processor 744 can use the object type to determine the movement pattern(s) for that object, including, for example, whether the object is an emergency vehicle, pedestrian, cyclist, obstruction (e.g., rock, tree, barricade, etc.), vehicle, or the like. For example, the movement pattern processor 744 can increase the likelihood that it determines an erratic movement pattern of an object determined to be an active emergency vehicle (e.g., a police vehicle with emergency lights and siren).

The movement type processor 746 can determine a movement type for one or more objects in an image, based on the determined movement pattern output by the movement pattern processor 744 for that image, input to the movement recognition engine 740. For example, the movement type processor 746 can determine whether an object is at a specific stage of a movement pattern output by the movement pattern processor 744 for that object. For example, the movement type processor 746 can determine that vehicle 540 is accelerating at image 622 and can determine that vehicle 650 has slowed (or possibly stopped) between images 642 and 640. As another example, the movement type processor 746 can determine that the vehicle 540 is at various stages of swerving in images 630, 632, and 634 and it can further determine that, in images 640, 642, and 644, the vehicle 650 is avoiding, or reacting to, the erratic swerving of vehicle 540.

For example, the system 700 can generate, via the trained machine learning model, the output indicating the pattern of movement of a second object. The system 700 can link, based on a feature of a predetermined pattern of movement, the pattern of movement with the predetermined type of movement. For example, the system 700 can generate, via the trained machine learning model, the output indicating a second pattern of movement of a third object, the second pattern of movement intersecting with the pattern of movement in one or more of the second plurality of images. For example, the system 700 can generate, via the trained machine learning model, the output (e.g., output by movement pattern processor 744) indicating the pattern of movement of a second object and indicating a second pattern of movement of a third object. The system 700 can link, based on a feature of a predetermined pattern of movement, the pattern of movement and the second pattern of movement with the predetermined type of movement (e.g., via movement type processor 746).

For example, the system 700 can include the physical environment corresponding to a roadway, and the one or more objects corresponding to one or more of a vehicle, a person, an item of debris, or any combination thereof located at least partially in the roadway. For example, the computer readable medium can include one or more instructions executable by a processor. The processor can generate via the trained machine learning model, the output indicating the pattern of movement of a second object. The processor can link, based on a feature of a predetermined pattern of movement, the pattern of movement with the predetermined type of movement. For example, the computer readable medium can include one or more instructions executable by a processor. The processor can generate, via the trained machine learning model, the output indicating a second pattern of movement of a third object, the second pattern of movement intersecting with the pattern of movement in one or more of the second plurality of images.

For example, the computer readable medium can include one or more instructions executable by a processor. The processor can generate, via the trained machine learning model, the output indicating the pattern of movement of a second object and indicating a second pattern of movement of a third object. The processor can link, based on a feature of a predetermined pattern of movement, the pattern of movement and the second pattern of movement with the predetermined type of movement.

FIG. 8 depicts an example method of using artificial intelligence to determine time segments of video data and associated object movement patterns, in accordance with present implementations. The method 800 can be performed by at least the processor 210 of the autonomy system 250 depicted in FIG. 2 or, in some examples, the machine learning model architecture 700 (e.g., as implemented by the processor 210), but it not limited thereto. Accordingly, one or more of the steps may be performed by a different processor, server, or any other computing device. For instance, one or more of the steps may be performed via a cloud-based service including any number of servers, which may be in communication with the processor of the autonomous vehicle and/or its autonomy system (e.g., remote server 270 of FIG. 2 or remote server 410a of FIG. 4). Although the steps are shown in FIG. 8 having a particular order, it is intended that the steps of the method 800 may be performed in any order. It is also intended that some of these steps may be, in some examples, optional or omitted. The method 800 may be executed to improve the processing of image data collected from cameras mounted on autonomous vehicles by partitioning a plurality of image data collected over time (e.g., video data) into one or more segments of image data, including the corresponding time stamps, and, in some examples, removing one or more images from the segments of image data based on one or more keyframes identified for the segments of image data.

At 810, the method 800 can obtain a first plurality of images. At 812, the method 800 can obtain images each including corresponding first time stamps. At 814, the method 800 can obtain the plurality of images for video data of a physical environment. At 816, the method 800 can obtain by one or more processors coupled with non-transitory memory.

At 820, the method 800 can extract a second plurality of images. At 822, the method 800 can extract images each having corresponding second time stamps. At 824, the method 800 can extract images each having corresponding features indicating an object in the physical environment. At 826, the method 800 can extract a plurality of images (e.g., a second or third plurality of images) from among the first plurality of images. For example, at 828, the method 800 can extract, by the one or more processors, a second plurality of images from the first plurality of images.

FIG. 9 depicts an example method of using artificial intelligence to determine time segments of video data and associated object movement patterns, in accordance with present implementations. The method 900 can be performed by at least the processor 210 of the autonomy system 250 depicted in FIG. 2, but is not limited thereto. Accordingly, one or more of the steps may be performed by a different processor, server, or any other computing device (e.g., remote server 270 of FIG. 2 or remote server 410a of FIG. 4). For instance, one or more of the steps may be performed via a cloud-based service including any number of servers, which may be in communication with the processor of the autonomous vehicle and/or its autonomy system. Although the steps are shown in FIG. 9 having a particular order, it is intended that the steps may be performed in any order. It is also intended that some of these steps may be optional. The method 900 may be executed to improve the processing of image data collected from cameras mounted on autonomous vehicles by partitioning a plurality of image data collected over time (e.g., video data) into one or more segments of image data, including the corresponding time stamps, and, in some examples, removing one or more images from the segments of image data based on one or more keyframes identified for the segments of image data.

At 910, the method 900 can train a machine learning model to generate an output indicating a pattern of movement. At 912, the method 900 can generate an output indicating a pattern of movement from one or more objects and the second time stamps for the objects. At 914, the method 900 can train with input including the features and the second time stamps for the features. For example, the method 900 can include selecting, by the one or more processors and based on a frame rate of the video data, a second plurality of images corresponding to the second time stamps, which are separated by a time interval corresponding to the frame rate. For example, the method can include extracting, by the one or more processors and via a second machine learning model trained with input that can include a third plurality of images having one or more second features indicating objects in the physical environment, the second plurality of images. At 916, the method 900 can train by the one or more processors.

For example, the method 900 can include selecting, by the one or more processors and based on a predetermined time period, the second plurality of images, a difference between an earliest time stamp among the second time stamps and a latest time stamp among the second time stamps less than or equal to the predetermined time period. For example, the method can include generating, by the one or more processors via the trained machine learning model, the output indicating the pattern of movement of a second object. The method can include linking, by the one or more processors and based on a feature of a predetermined pattern of movement, the pattern of movement with the predetermined type of movement.

For example, the method 900 can include generating, by the one or more processors via the trained machine learning model, the output indicating a second pattern of movement of a third object, the second pattern of movement intersecting with the pattern of movement in one or more of the second plurality of images.

For example, the method 900 can include generating, by the one or more processors via the trained machine learning model, the output indicating the pattern of movement of a second object and indicating a second pattern of movement of a third object. The method 900 can include linking, by the one or more processors and based on a feature of a predetermined pattern of movement, the pattern of movement and the second pattern of movement with the predetermined type of movement.

For example, the method 900 can include the physical environment corresponding to a roadway, and the one or more objects corresponding to one or more of a vehicle, a person, an item of debris, or any combination thereof located at least partially in the roadway. For example, the system can extract, via a second machine learning model trained with input can include a third plurality of images having one or more second features indicating objects in the physical environment, the second plurality of images. For example, the system can select, based on a frame rate of the video data, the second plurality of images, the second time stamps separated by a time interval corresponding to the frame rate. For example, the system can select, based on a predetermined time period, the second plurality of images, a difference between an earliest time stamp among the second time stamps and a latest time stamp among the second time stamps less than or equal to the predetermined time period.

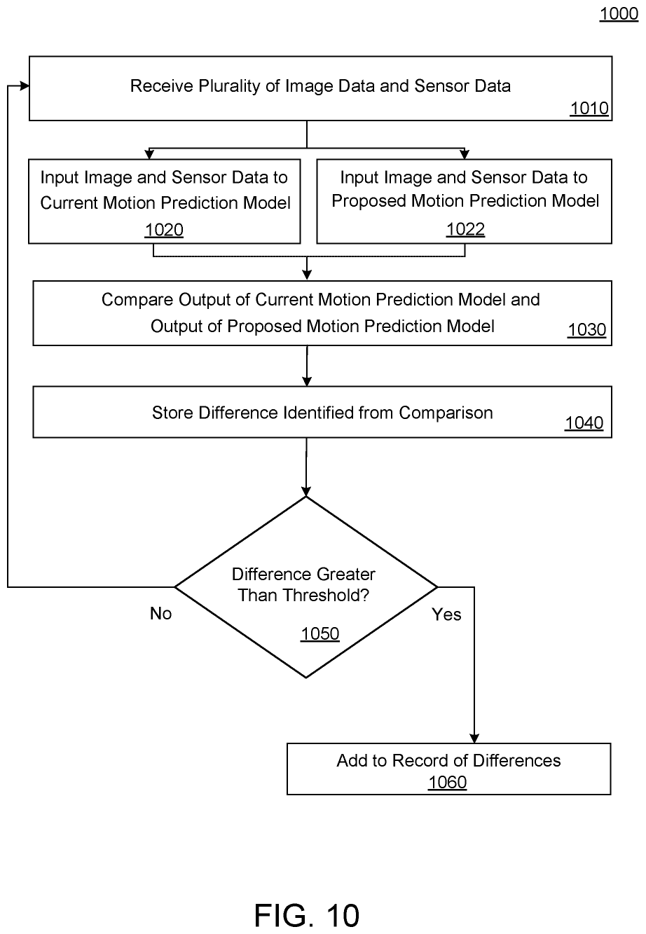

FIG. 10 depicts an example method 1000 of comparing the motion predictions for one or more time segments of video data and the associated object movement patterns produced by a machine leaning-based model and actual measured motion, in accordance with present implementations. The method 1000 can be performed by at least the processor 210 of the autonomy system 250 depicted in FIG. 2, but is not limited thereto. Accordingly, one or more of the steps may be performed by a different processor, server, or any other computing device (e.g., remote server 270 of FIG. 2 or remote server 410a of FIG. 4). For instance, one or more of the steps may be performed via a cloud-based service including any number of servers, which may be in communication with the processor of the autonomous vehicle and/or its autonomy system. Although the steps are shown in FIG. 10 having a particular order, it is intended that the steps may be performed in any order. It is also intended that some of these steps may be optional. The method 1000 may be executed to improve the processing of image data collected from cameras mounted on autonomous vehicles by partitioning a plurality of image data collected over time (e.g., video data) into one or more segments of image data, including the corresponding time stamps, and, in some examples, removing one or more images from the segments of image data based on one or more keyframes identified for the segments of image data.

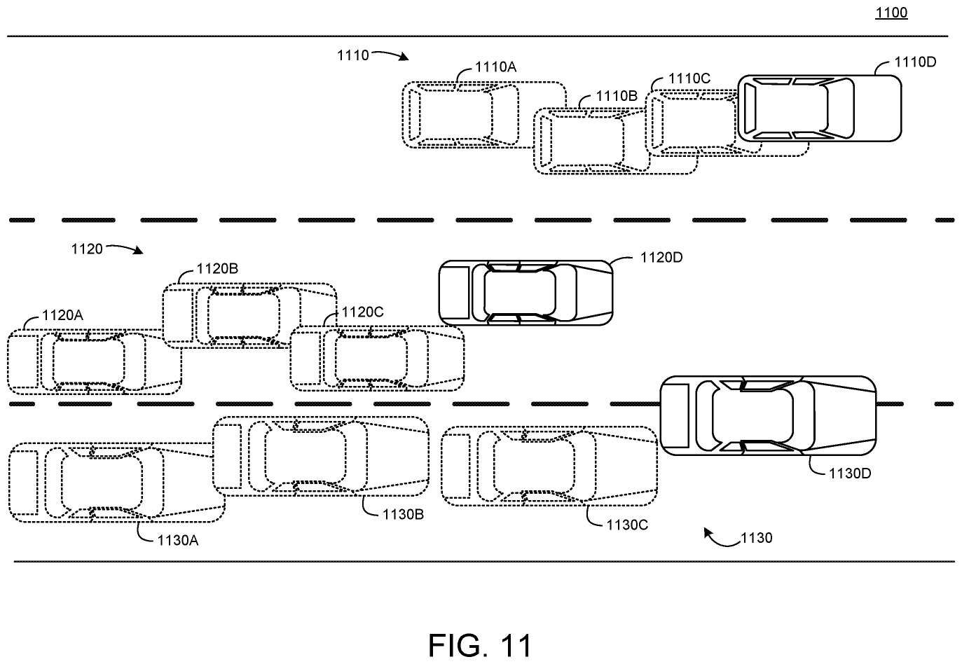

At 1010 the method 1000 can receive (e.g., access) a plurality of image data for video data and corresponding sensor data of one or more vehicles in a physical environment. For example, at 1010 the method can access a portion of video data and corresponding sensor data for a plurality of vehicles (e.g., vehicles 1110, 1120, and 1130 shown in, and described with reference to, FIG. 11). At 1010 the method 1000 can access the plurality of image data for video data and corresponding sensor data from a non-transitory storage medium.

At 1020 the method 1000 can input (e.g., provide) the plurality of image data and corresponding sensor data to a current (e.g., existing) movement pattern prediction model (e.g., one or more machine learning models, as described above). At 1022 the method 1000 can input (e.g., provide) the plurality of image data and corresponding sensor data to one or more proposed (e.g., comparison) movement pattern prediction models (e.g., one or more machine learning models, as described above).

At 1030 the method 1000 can compare the output of the current (e.g., existing) movement pattern prediction model (e.g., the output of the one or more machine learning models of 1020) with the output of the one or more proposed (e.g., comparison) movement pattern prediction models (e.g., the one or more proposed machine learning models of 1022). For example, at 1030 the method 1000 can determine a difference (e.g., a difference vector) between the two outputs (e.g., provided by the machine learning models of 1020, 1022), which can include a difference that is zero, or substantially close to zero. In some examples, the method 1000 can, at 1030, determine a difference (e.g., difference vector) between the movement pattern (e.g., movement prediction) output by the two different machine learning models of 1020 and 1022. Additionally, in some examples, the method 1000 can determine a difference according to the operation of the movement comparison processor 738 shown in, and described with reference to, FIG. 7.

At 1040 the method 1000 can store the difference (e.g., the difference vector) determined at 1030. For example, the method 1000 can store each difference vector (e.g., in a cache of difference results). At 1050 the method 1000 can determine whether the difference determined at 1030 is greater than a predetermined value (e.g., a difference threshold). If the difference is greater than the predetermined value the method 1000 can, at 1060, add (e.g., store) the difference in a record of one or more differences (e.g., one or more previously determined difference vectors). If the difference is not greater than the predetermined value the method 1000 can repeat, which can include repeating method 1000 starting at 1010.

FIG. 11 depicts an example augmentation 1100 for a machine learning based model to predict the motion of one or more vehicles, in accordance with present implementations. FIG. 11 includes an ego vehicle 1120 over time, which includes the position of the ego vehicle at a first time 1120A, at a second time 1120B, at a third time 1120C, and at a fourth time 1120D. Further, augmentation 1100 depicts a first vehicle 1100, which includes a movement pattern that reacts to the movement of the ego vehicle 1120, at a first time 1110A, at a second time 1110B, at a third time 1110C, and at a fourth time 1110D. Similarly, augmentation 1100 depicts a second vehicle 1130, which includes a movement pattern that reacts to the movement of the ego vehicle 1120, at a first time 1130A, at a second time 1130B, at a third time 1130C, and at a fourth time 1130D.

Having now described some illustrative implementations, the foregoing is illustrative and not limiting, having been presented by way of example. In particular, although many of the examples presented herein involve specific combinations of method acts or system elements, those acts and those elements may be combined in other was to accomplish the same objectives. Acts, elements and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B” can include only ‘A’, only ‘B’, as well as both “A′ and ‘B’. Such references used in conjunction with “comprising” or other open terminology can include additional items. References to “is” or “are” may be construed as nonlimiting to the implementation or action referenced in connection with that term. The terms “is” or “are” or any tense or derivative thereof, are interchangeable and synonymous with “can be” as used herein, unless stated otherwise herein.

Directional indicators depicted herein are example directions to facilitate understanding of the examples discussed herein, and are not limited to the directional indicators depicted herein. Any directional indicator depicted herein can be modified to the reverse direction, or can be modified to include both the depicted direction and a direction reverse to the depicted direction, unless stated otherwise herein. While operations are depicted in the drawings in a particular order, such operations are not required to be performed in the particular order shown or in sequential order, and all illustrated operations are not required to be performed. Actions described herein can be performed in a different order. Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Scope of the systems and methods described herein is thus indicated by the appended claims, rather than the foregoing description. The scope of the claims includes equivalents to the meaning and scope of the appended claims.

What is claimed is:

1. A method, comprising:
obtaining, by one or more processors coupled with non-transitory memory, a first plurality of images each including corresponding first time stamps, the plurality of images corresponding to video data of a physical environment;
extracting, by the one or more processors and from among the first plurality of images, a second plurality of images each having corresponding second time stamps and each having corresponding features indicating an object in the physical environment; and
training, by the one or more processors and with input including the features and the second time stamps corresponding to the features, a machine learning model to generate an output indicating a pattern of movement of one or more objects corresponding to the features and the second time stamps corresponding to the features.

2. The method of claim 1, further comprising:
extracting, by the one or more processors and via a second machine learning model trained with input including a third plurality of images having one or more second features indicating objects in the physical environment, the second plurality of images.

3. The method of claim 1, further comprising:
selecting, by the one or more processors and based on a frame rate of the video data, the second plurality of images, the second time stamps separated by a time interval corresponding to the frame rate.

4. The method of claim 1, further comprising:
selecting, by the one or more processors and based on a predetermined time period, the second plurality of images, a difference between an earliest time stamp among the second time stamps and a latest time stamp among the second time stamps less than or equal to the predetermined time period.

5. The method of claim 1, further comprising:
generating, by the one or more processors via the trained machine learning model, the output indicating the pattern of movement of a second object; and
linking, by the one or more processors and based on a feature of a predetermined pattern of movement, the pattern of movement with the predetermined type of movement.

6. The method of claim 5, further comprising:
generating, by the one or more processors via the trained machine learning model, the output indicating a second pattern of movement of a third object, the second pattern of movement intersecting with the pattern of movement in one or more of the second plurality of images.

7. The method of claim 1, further comprising:
generating, by the one or more processors via the trained machine learning model, the output indicating the pattern of movement of a second object and indicating a second pattern of movement of a third object; and
linking, by the one or more processors and based on a feature of a predetermined pattern of movement, the pattern of movement and the second pattern of movement with the predetermined type of movement.

8. The method of claim 1, the physical environment corresponding to a roadway, and the one or more objects corresponding to one or more of a vehicle, a person, an item of debris, or any combination thereof located at least partially in the roadway.

9. A system, comprising:
one or more processors coupled to non-transitory memory, the one or more processors configured to:
obtain a first plurality of images each including corresponding first time stamps, the plurality of images corresponding to video data of a physical environment;
extract, from among the first plurality of images, a second plurality of images each having corresponding second time stamps and each having corresponding features indicating an object in the physical environment; and
train, with input including the features and the second time stamps corresponding to the features, a machine learning model to generate an output indicating a pattern of movement of one or more objects corresponding to the features and the second time stamps corresponding to the features.

10. The system of claim 9, the processors further configured to:
extract, via a second machine learning model trained with input including a third plurality of images having one or more second features indicating objects in the physical environment, the second plurality of images.

11. The system of claim 9, the processors further configured to:
select, based on a frame rate of the video data, the second plurality of images, the second time stamps separated by a time interval corresponding to the frame rate.

12. The system of claim 9, the processors further configured to:
select, based on a predetermined time period, the second plurality of images, a difference between an earliest time stamp among the second time stamps and a latest time stamp among the second time stamps less than or equal to the predetermined time period.

13. The system of claim 9, the processors further configured to:
generate, via the trained machine learning model, the output indicating the pattern of movement of a second object; and
link, based on a feature of a predetermined pattern of movement, the pattern of movement with the predetermined type of movement.

14. The system of claim 13, the processors further configured to:
generate, via the trained machine learning model, the output indicating a second pattern of movement of a third object, the second pattern of movement intersecting with the pattern of movement in one or more of the second plurality of images.

15. The system of claim 9, the processors further configured to:
generate, via the trained machine learning model, the output indicating the pattern of movement of a second object and indicating a second pattern of movement of a third object; and
link, based on a feature of a predetermined pattern of movement, the pattern of movement and the second pattern of movement with the predetermined type of movement.

16. The system of claim 9, the physical environment corresponding to a roadway, and the one or more objects corresponding to one or more of a vehicle, a person, an item of debris, or any combination thereof located at least partially in the roadway.

17. A non-transitory computer readable medium including one or more instructions stored thereon and executable by a processor to:
obtain, by a processor, a first plurality of images each including corresponding first time stamps, the plurality of images corresponding to video data of a physical environment;
extract, by the processor from among the first plurality of images, a second plurality of images each having corresponding second time stamps and each having corresponding features indicating an object in the physical environment; and
train, by the processor with input including the features and the second time stamps corresponding to the features, a machine learning model to generate an output indicating a pattern of movement of one or more objects corresponding to the features and the second time stamps corresponding to the features.

18. The computer readable medium of claim 17, wherein the computer readable medium further includes one or more instructions executable by the processor to:
generate by the processor via the trained machine learning model, the output indicating the pattern of movement of a second object; and
link, by the processor and based on a feature of a predetermined pattern of movement, the pattern of movement with the predetermined type of movement.

19. The computer readable medium of claim 18, wherein the computer readable medium further includes one or more instructions executable by the processor to:
generate, by the processor via the trained machine learning model, the output indicating a second pattern of movement of a third object, the second pattern of movement intersecting with the pattern of movement in one or more of the second plurality of images.

20. The computer readable medium of claim 17, wherein the computer readable medium further includes one or more instructions executable by the processor to:
generate, by the processor via the trained machine learning model, the output indicating the pattern of movement of a second object and indicating a second pattern of movement of a third object; and
link, by the processor and based on a feature of a predetermined pattern of movement, the pattern of movement and the second pattern of movement with the predetermined type of movement.
